(19) United States
(12) Patent Application Publication
(10) Pub. No.: US 2024/0259169 A1
(43) Pub. Date: Aug. 1, 2024

(54) TECHNIQUES FOR ENHANCED CONTROL RESOURCE SET CONFIGURATIONS FOR FULL-DUPLEX OPERATIONS

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Jing SUN, San Diego, CA (US); Mostafa KHOSHNEVISAN, San Diego, CA (US); Ahmed Attia ABOTABL, San Diego, CA (US)

(21) Appl. No.: 18/162,358

(22) Filed: Jan. 31, 2023

(51) Int. Cl. H04L 5/00; H04L 5/14; H04W 72/0446

(52) U.S. Cl. CPC H04L 5/0094; H04L 5/14; H04W 72/0446

(57) ABSTRACT

Various aspects of the present disclosure generally relate to wireless communication. In some aspects, a user equipment (UE) may receive, from a network node, control resource set (CORESET) configuration information that is associated with one or more CORESETs. The UE may receive, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type. Numerous other aspects are described.

### FIELD OF THE DISCLOSURE

Aspects of the present disclosure generally relate to wireless communication and to techniques and apparatuses for enhanced control resource set (CORESET) configurations for full-duplex operations.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving, from a network node, control resource set (CORESET) configuration information that is associated with one or more CORESETs. The method may include receiving, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type.

Some aspects described herein relate to a method of wireless communication performed by a network node. The method may include transmitting CORESET configuration information, associated with a UE, that is associated with one or more CORESETs. The method may include transmitting, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type.

Some aspects described herein relate to a UE for wireless communication. The UE may include a memory and one or more processors coupled to the memory. The one or more processors may be configured to receive, from a network node, CORESET configuration information that is associated with one or more CORESETs. The one or more processors may be configured to receive, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type.

Some aspects described herein relate to a network node for wireless communication. The network node may include a memory and one or more processors coupled to the memory. The one or more processors may be configured to transmit CORESET configuration information, associated with a UE, that is associated with one or more CORESETs. The one or more processors may be configured to transmit, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type.

Some aspects described herein relate to a non-transitory computer-readable medium that stores a set of instructions for wireless communication by a UE. The set of instructions, when executed by one or more processors of the UE, may cause the UE to receive, from a network node, CORESET configuration information that is associated with one or more CORESETs. The set of instructions, when executed by one or more processors of the UE, may cause the UE to receive, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type.

Some aspects described herein relate to a non-transitory computer-readable medium that stores a set of instructions for wireless communication by a network node. The set of instructions, when executed by one or more processors of the network node, may cause the network node to transmit CORESET configuration information, associated with a UE, that is associated with one or more CORESETs. The set of instructions, when executed by one or more processors of the network node, may cause the network node to transmit, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type.

Some aspects described herein relate to an apparatus for wireless communication. The apparatus may include means for receiving, from a network node, CORESET configuration information that is associated with one or more CORESETs. The apparatus may include means for receiving, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type.

Some aspects described herein relate to an apparatus for wireless communication. The apparatus may include means for transmitting CORESET configuration information, associated with a UE, that is associated with one or more CORESETs. The apparatus may include means for transmitting, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example resource structure for wireless communication, in accordance with the present disclosure.

FIG. 5 is a diagram illustrating an example of control resource set (CORESET) interleaving, in accordance with the present disclosure.

FIG. 6 is a diagram illustrating examples of full-duplex communication in a wireless network, in accordance with the present disclosure.

FIG. 7 is a diagram illustrating examples of full-duplex communications, in accordance with the present disclosure.

FIG. 8 is a diagram illustrating an example of a subband full-duplex (SBFD) slot format, in accordance with the present disclosure.

FIG. 9 is a diagram illustrating an example of a control channel monitoring occasion included in a full-duplex slot, in accordance with the present disclosure.

FIG. 10 is a diagram of an example associated with enhanced CORESET configurations for full-duplex operations, in accordance with the present disclosure.

FIG. 11 is a diagram of an example associated with enhanced CORESET configurations for full-duplex operations, in accordance with the present disclosure.

FIG. 12 is a diagram of an example associated with enhanced CORESET configurations for full-duplex operations, in accordance with the present disclosure.

FIG. 13 is a diagram illustrating an example process performed, for example, by a UE, in accordance with the present disclosure.

FIG. 14 is a diagram illustrating an example process performed, for example, by a network node, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

Aspects of the present disclosure provide apparatuses, methods, processing systems, and/or computer-readable mediums for enhanced control resource set (CORESET) configuration for full-duplex operations.

For example, a potential control region of a slot may be referred to as a CORESET and may be structured to support an efficient use of resources, such as by flexible configuration or reconfiguration of resources of the CORESET for one or more physical downlink control channel (PDCCHs) and/or one or more physical downlink shared channels (PDSCHs). A CORESET may include a plurality of resource blocks (RBs) in the frequency domain, and either one, two, or three symbols in the time domain. A number of resources included in the CORESET may be flexibly configured, such as by using radio resource control (RRC) signaling to indicate a frequency domain region (e.g., a number of resource blocks) and/or a time domain region (e.g., a number of symbols) for the CORESET. A symbol that includes the CORESET may include one or more control channel elements (CCEs) that span a portion of the system bandwidth.

“Full-duplex communication” in a wireless network refers to simultaneous bi-directional communication between devices in the wireless network. For example, a user equipment (UE) operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol). For example, for full-duplex communications, a downlink bandwidth part (BWP) and an uplink BWP may be active at the same time (e.g., using the same, or at least partially overlapping, time domain resources). The downlink and uplink transmissions may occur in overlapping bands (e.g., in-band full-duplex (IBFD)) or in adjacent bands (e.g., subband full-duplex (SBFD)). In a given downlink and uplink slot symbol, a half-duplex UE may either transmit in an uplink band or receive in a downlink band. In a given downlink and uplink slot symbol, a full-duplex UE may transmit in an uplink band and/or receive in a downlink band (e.g., in the same slot).

A control channel monitoring occasion (e.g., a PDCCH monitoring occasion) may be configured to occur during a full-duplex slot, such as an SBFD slot. For example, a CORESET may be configured (e.g., by a CORESET configuration and/or a search space configuration) in the full-duplex slot. A UE may be configured to monitor resources associated with the CORESET to receive a downlink communication (e.g., a PDCCH communication).

However, in some cases, the resources (e.g., frequency domain resources) associated with a configured CORESET may at least partially overlap with uplink resources (e.g., an uplink subband) and/or with resources associated with a guard band of the full-duplex slot. For example, in some cases, the UE and a network node may switch slot patterns and/or slot types used over time. However, a CORESET configuration may be a relatively static configuration (e.g., an RRC configuration) that does not change over time (or that changes infrequently over time). As a result, a CORESET configuration and/or a search space configuration may result in monitoring occasions that occur in a first slot type (e.g., a half-duplex slot) at one time and that occur in a second slot type (e.g., a full-duplex slot) at another time.

Therefore, the UE may be configured to monitor for downlink transmissions (e.g., in accordance with the CORESET configuration and/or the search space configuration) using frequency domain resources that are also configured for transmitting uplink transmissions (e.g., in accordance with the full-duplex slot configuration). In other words, one or more RBs of the full-duplex slot may be configured for both uplink transmissions and downlink transmissions. In some cases, the UE may not be capable of transmitting and receiving using the same time domain and frequency domain resources. In such examples, how the UE is to handle the resources that are configured for both uplink transmissions and downlink transmissions may be unclear. For example, the UE may use the resources for uplink transmissions, thereby increasing a likelihood that the UE is unable to detect, decode, and/or receive a control channel communication (e.g., a PDCCH communication) that is transmitted via the CORESET. Alternatively, the UE may use the resources for downlink transmissions (e.g., increasing a likelihood that the UE is able to detect, decode, and/or receive a control channel communication), thereby reducing resources available for uplink transmissions by the UE, and thereby reducing a throughput, reducing performance, and/or increasing latency, among other examples, associated with the uplink transmissions.

Some techniques and apparatuses described herein enable enhanced CORESET configurations for full-duplex operations. In some aspects, a UE and/or a network node may be enabled to handle CORESET configurations that are associated with frequency domain resources that at least partially overlap with uplink resources (and/or guard band resources) of a full-duplex slot, such as an SBFD slot. For example, the UE and/or the network node may adapt a CORESET configuration based at least in part on a slot type of a slot in which a monitoring occasion associated with the CORESET occurs. In some aspects, the UE and/or the network node may adapt a CORESET configuration to cause the CORESET to be associated with fully configured frequency domain resources (e.g., all configured CCEs) for half-duplex slots and to be associated with frequency domain resources (e.g., CCEs) that do not overlap with uplink resources (and/or guard band resources) for full-duplex slots.

As a result, the UE and the network node may be enabled to deal with CORESET resources that overlap with uplink resources (and/or guard band resources) of full-duplex slots in an efficient and synchronized manner. For example, this ensures that the UE and the network node are synchronized on how the overlapping resources will be utilized (e.g., for uplink transmissions or downlink transmission). Additionally, adapting the CORESET configuration (e.g., prior to performing PDCCH candidate-to-CCE mapping and/or interleaving) reduces processing resources, memory resources, and/or power resources, among other examples, that would have otherwise been used to perform PDCCH-candidate-to-CCE mapping and/or interleaving and to identify PDCCH candidates that are mapped to frequency resources that at least partially overlap with uplink resources and/or guard band resources of the full-duplex slot. As another example, this increases network resource utilization by enabling a full-duplex slot type to be used by the UE and the network node (e.g., by using both a downlink BWP and an uplink BWP simultaneously instead of only the downlink BWP or the uplink BWP).

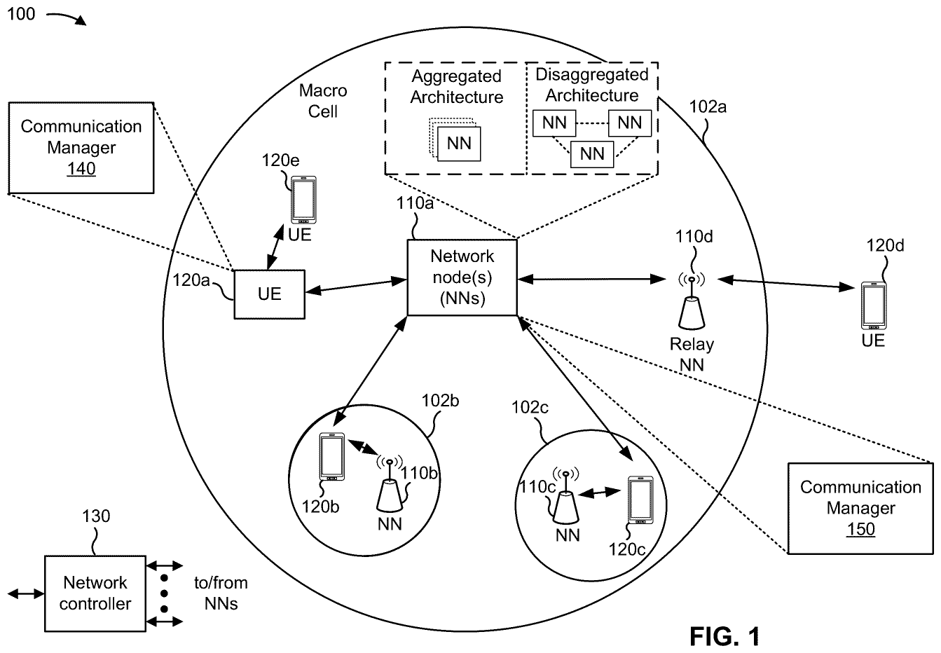

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a network node, CORESET configuration information that is associated with one or more CORESETs; and receive, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type. Additionally, or alternatively, the communication manager 140 may perform one or more other operations described herein.

In some aspects, the network node 110 may include a communication manager 150. As described in more detail elsewhere herein, the communication manager 150 may transmit CORESET configuration information, associated with a UE, that is associated with one or more CORESETs; and transmit, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type. Additionally, or alternatively, the communication manager 150 may perform one or more other operations described herein.

As indicated above, FIG. 1 is provided as an example. Other examples may differ from what is described with regard to FIG. 1.

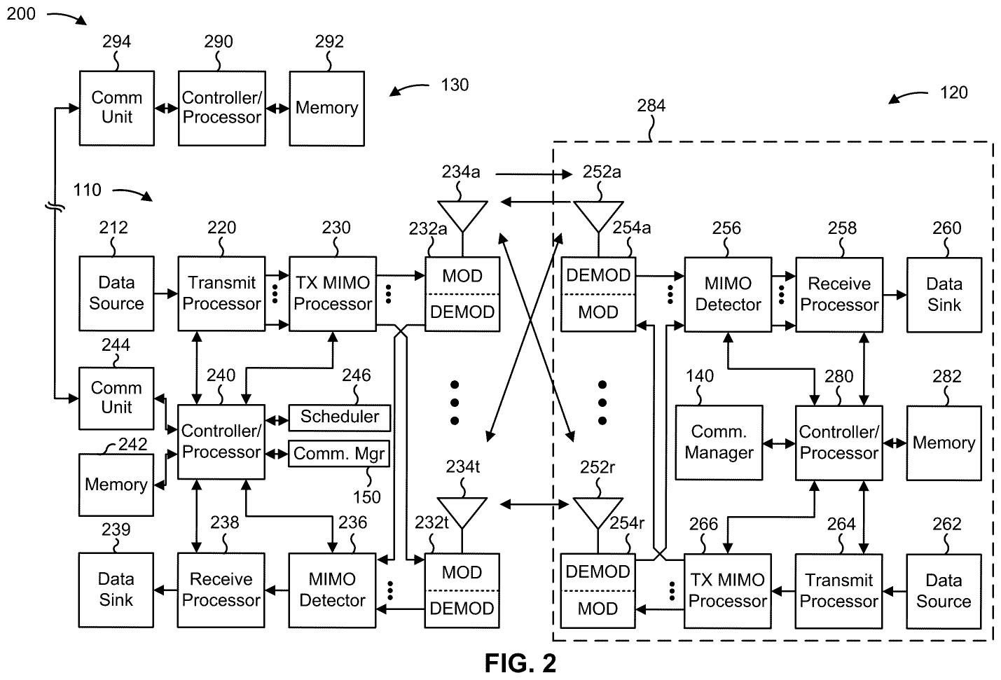

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

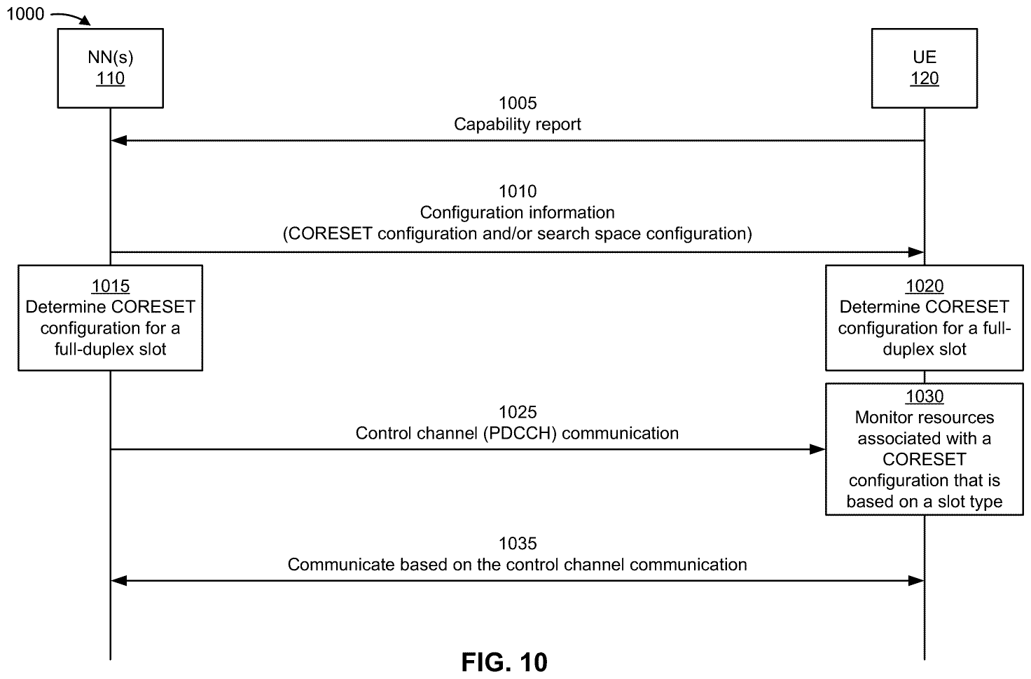

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 10-16).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 10-16).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

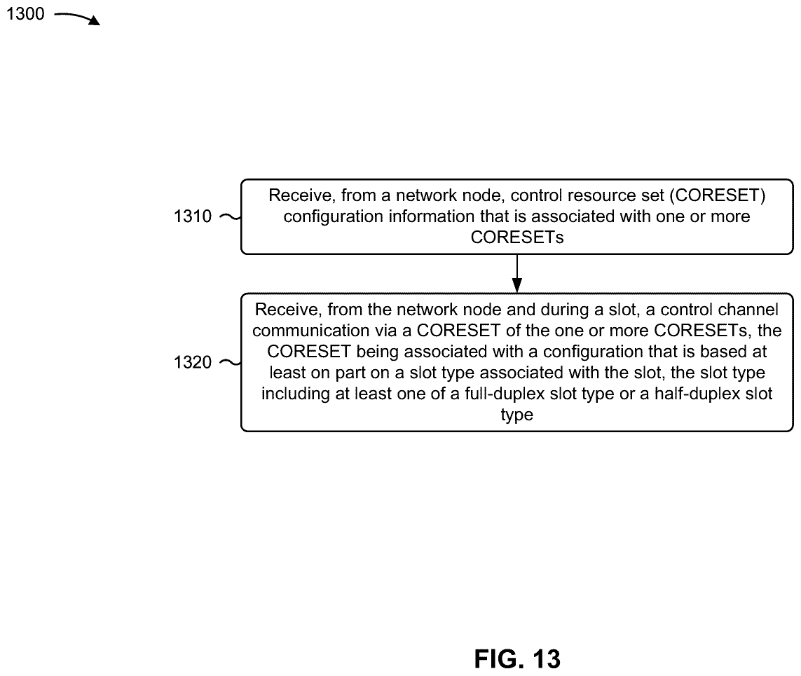

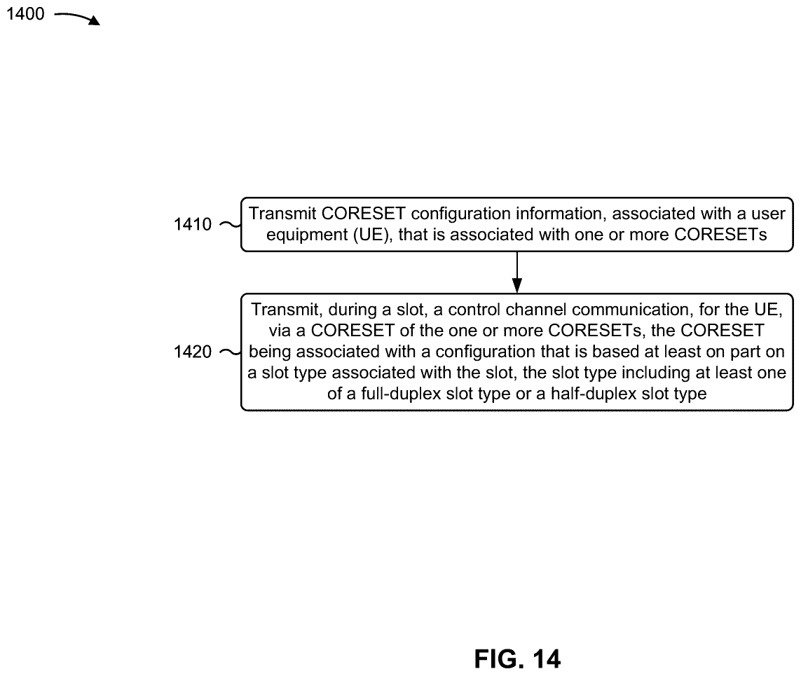

The controller/processor 240 of the network node 110, the controller/processor 280 of the UE 120, or any other component(s) of FIG. 2 may perform one or more techniques associated with enhanced CORESET configurations for full-duplex operations, as described in more detail elsewhere herein. For example, the controller/processor 240 of the network node 110, the controller/processor 280 of the UE 120, or any other component(s) (or combinations of components) of FIG. 2 may perform or direct operations of, for example, process 1300 of FIG. 13, process 1400 of FIG. 14, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE 120 includes means for receiving, from a network node, CORESET configuration information that is associated with one or more CORESETs; and/or means for receiving, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting CORESET configuration information, associated with a UE, that is associated with one or more CORESETs; and/or means for transmitting, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

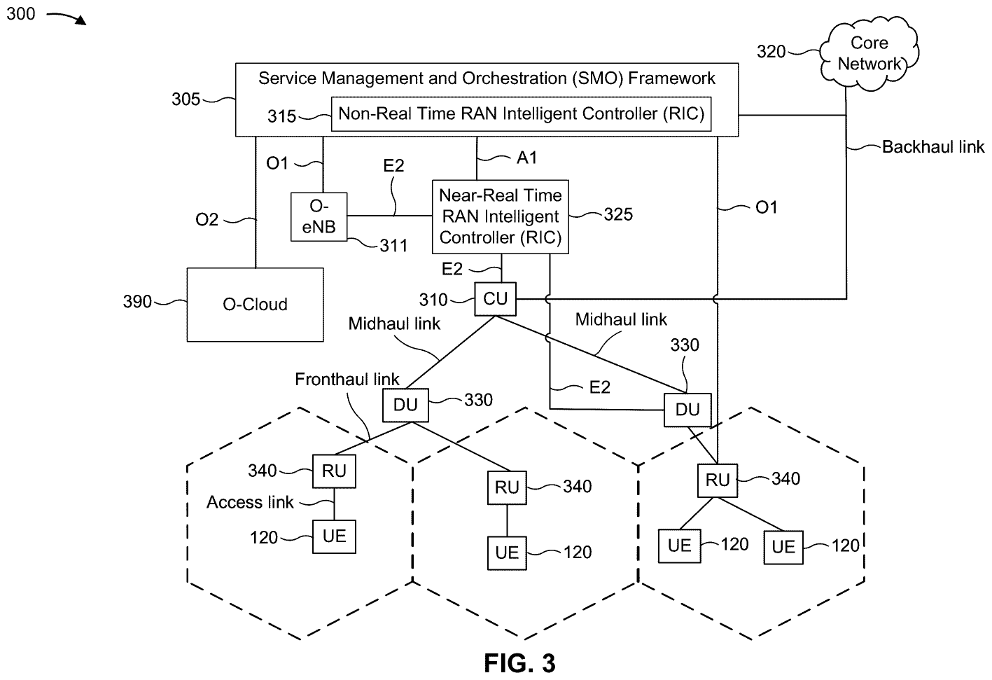

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

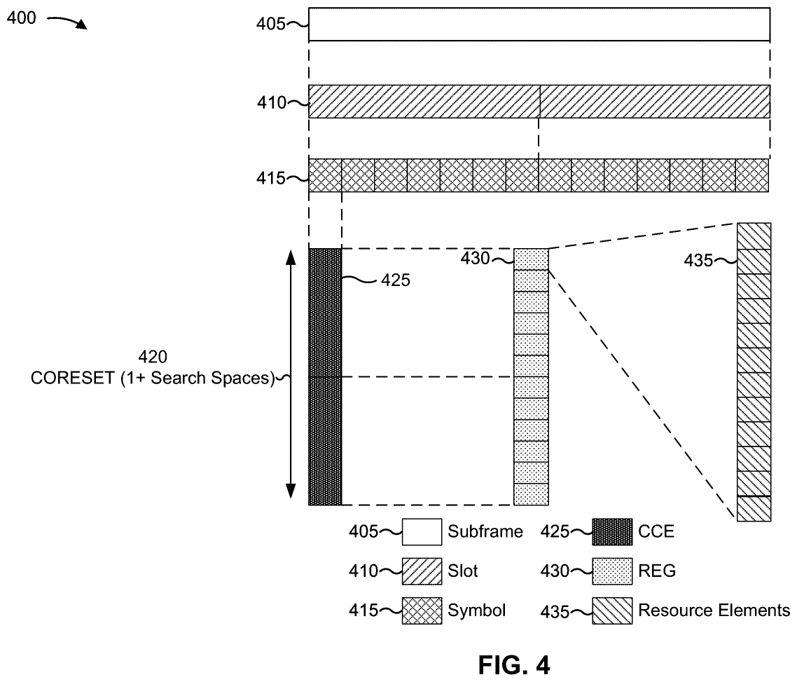

FIG. 4 is a diagram illustrating an example resource structure 400 for wireless communication, in accordance with the present disclosure. Resource structure 400 shows an example of various groups of resources described herein. As shown, resource structure 400 may include a subframe 405. Subframe 405 may include multiple slots 410. While resource structure 400 is shown as including 2 slots per subframe, a different number of slots may be included in a subframe (e.g., 4 slots, 8 slots, 16 slots, 32 slots, or another number of slots). In some examples, different types of transmission time intervals (TTIs) may be used, other than subframes and/or slots. A slot 410 may include multiple symbols 415, such as 14 symbols per slot.

The potential control region of a slot 410 may be referred to as a CORESET 420 and may be structured to support an efficient use of resources, such as by flexible configuration or reconfiguration of resources of the CORESET 420 for one or more PDCCHs and/or one or more physical downlink shared channels (PDSCHs). In some examples, the CORESET 420 may occupy the first symbol 415 of a slot 410, the first two symbols 415 of a slot 410, or the first three symbols 415 of a slot 410, among other examples. Thus, a CORESET 420 may include a plurality of resource blocks (RBs) in the frequency domain, and either one, two, or three symbols 415 in the time domain. In 5G, a number of resources included in the CORESET 420 may be flexibly configured, such as by using RRC signaling to indicate a frequency domain region (e.g., a number of resource blocks) and/or a time domain region (e.g., a number of symbols) for the CORESET 420.

As illustrated, a symbol 415 that includes CORESET 420 may include one or more control channel elements (CCEs) 425, shown as two CCEs 425 as an example, that span a portion of the system bandwidth. A CCE 425 may include downlink control information (DCI) that is used to provide control information for wireless communication. A network node may transmit DCI during a plurality of CCEs 425 (as shown), where the number of CCEs 425 used for transmission of DCI represents the aggregation level (AL) used by the network node for the transmission of DCI. In FIG. 4, an aggregation level of two is shown as an example, corresponding to two CCEs 425 in a slot 410. In some examples, different aggregation levels may be used, such as 1, 2, 4, 8, 16, or another aggregation level.

Each CCE 425 may include a fixed number of resource element groups (REGs) 430, shown as 6 REGs 430, or may include a variable number of REGs 430. In some examples, the number of REGs 430 included in a CCE 425 may be specified by a REG bundle size. A REG 430 may include one resource block, which may include 12 resource elements (REs) 435 within a symbol 415. A resource element 435 may occupy one subcarrier in the frequency domain and one OFDM symbol in the time domain.

A search space may include all possible locations (e.g., in time and/or frequency) where a PDCCH may be located. A CORESET 420 may be associated with one or more search spaces, such as a UE-specific search space, a group-common search space, and/or a common search space (CSS). For example, the CORESET 420 may define the frequency domain location (e.g., RBs) and/or time duration (e.g., number of consecutive symbols) of a control region of the PDCCH. A search space (or a search space set) associated with the CORESET 420 may define a slot pattern and/or a starting symbol of the control region of the PDCCH (e.g., in each slot that contains the CORESET 420 as defined by the slot pattern). A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for a plurality of UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. In other words, a UE-specific search space may be a search space that is defined, or configured, for a given UE. A common search space may be a search space that is defined, or configured, for multiple (or for all) UEs (e.g., all UEs with an established connection with a given network node). A common search space may be used for monitoring a common PDCCH and a UE-specific search space may be used for monitoring a UE-dedicated search space. One or more search spaces across aggregation levels may be referred to as a search space (SS) set.

A CORESET 420 may be interleaved or non-interleaved. An interleaved CORESET 420 may have CCE-to-REG mapping such that adjacent CCEs are mapped to scattered REG bundles in the frequency domain (e.g., adjacent CCEs are not mapped to consecutive REG bundles of the CORESET 420). A non-interleaved CORESET 420 may have a CCE-to-REG mapping such that all CCEs are mapped to consecutive REG bundles (e.g., in the frequency domain) of the CORESET 420.

In some examples, the CORESET 420 may be configured via CORESET configuration information. The CORESET configuration information may be included in an RRC configuration (e.g., one or more information elements of an RRC configuration). For example, the CORESET configuration information may be included in a ControlResourceSet RRC information element. The CORESET configuration information may indicate frequency domain resources associated with the CORESET 420. For example, the CORESET configuration information may include an indication of RBs that are associated with the CORESET 420. As an example, the CORESET configuration information may include a bitmap indicating RBs that are associated with the CORESET 420 (e.g., in a frequencyDomainResources information element). For example, the bitmap may include N bits, where each bit represents 6 REGs (e.g., each bit represents 6 RBs and/or 1 CCE). The bitmap may indicate which RBs, included in a configured bandwidth part (BWP), are to be associated with the CORESET 420. The CORESET configuration information may include an indication of a CCE-to-REG mapping type (e.g., interleaved or non-interleaved). The CORESET configuration information may include additional information associated with the CORESET 420 (e.g., as defined, or otherwise fixed, by a wireless communication standard, such as the 3GPP).

In some cases, a UE (e.g., a UE 120) may receive and/or decode a master information block (MIB). The MIB may include frequency and timing information to allow the UE to establish an RRC connection with a cell including the network node 110, as well as including information for scheduling reception of remaining minimum system information (RMSI) by the UE. For example, the MIB may include a pdcch-ConfigSIBI data structure (e.g., as defined in 3GPP specifications and/or another standard) and/or another similar data structure defining a search space (e.g., in a PDCCH) in which the UE may receive scheduling information for the RMSI. This search space may be referred to as a Type0-PDCCH CSS. In some examples, the MIB may include information associated with a CORESET configuration defining physical resources (e.g., one or more frequency resources, one or more time resources, and/or other resources) for monitoring the Type0-PDCCH CSS. Accordingly, this CORESET may be referred to as a Type0-PDCCH CORESET.

For other CSSs (e.g., a TypeOA-PDCCH CSS associated with additional SIB messages, a Type1-PDCCH CSS associated with a random access response (RAR), and/or a Type2-PDCCH CSS associated with a paging occasion (PO)), the network node 110 may instruct the UE to monitor a similar set of monitoring occasions that includes monitoring occasions in consecutive slots (e.g., by setting a SearchSpaceld for searchSpaceOtherSystemInformation, ra-SearchSpace, and/or pagingSearchSpace in PDCCH-ConfigCommon, as defined in 3GPP specifications and/or another standard, to zero). These other CSSs may similarly be associated with corresponding CORESET configurations defining physical resources for monitoring the CSSs (e.g., a TypeOA PDCCH CSS, a Type1 PDCCH CSS, and/or a Type2 PDCCH CSS, as described above). Accordingly, these corresponding CORESETs may be referred to as a Type0A PDCCH CORESET, a Type1 PDCCH CORESET, or a Type2 PDCCH CORESET, respectively. In some examples, there may be a limit (e.g., defined, or otherwise fixed, by a wireless communication standard, such as the 3GPP) for a number of CORESETs and/or a number of SS sets that can be configured for an active BWP of the UE.

As indicated above, FIG. 4 is provided as an example. Other examples may differ from what is described with respect to FIG. 4.

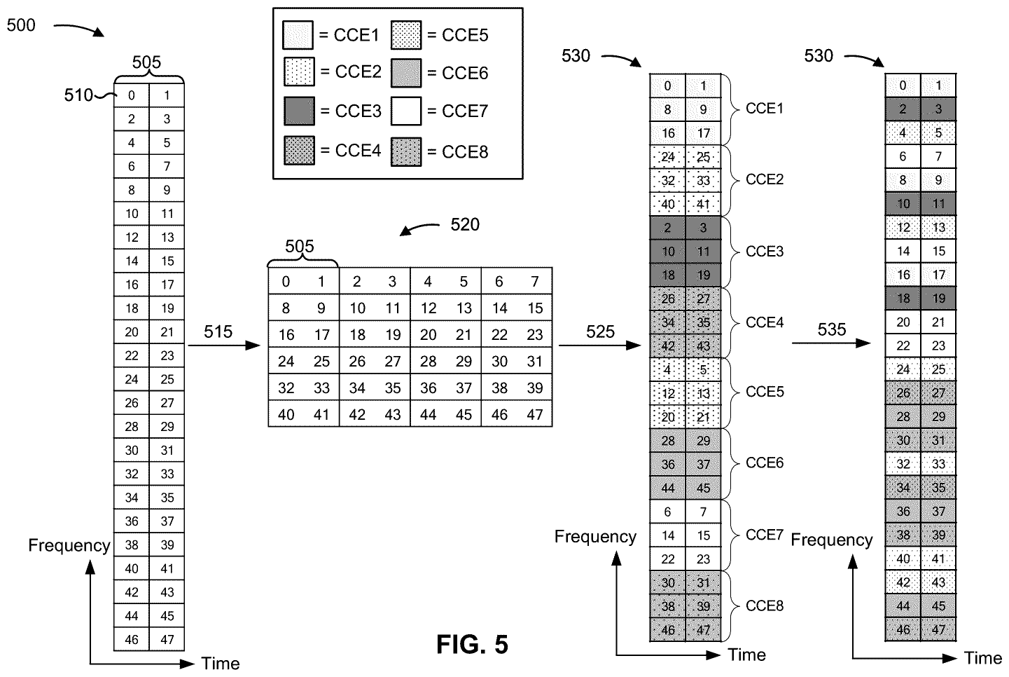

FIG. 5 is a diagram illustrating an example 500 of CORESET interleaving, in accordance with the present disclosure. For example, the example 500 may be associated with an example of interleaving a CORESET that is associated with three or fewer symbols. As shown in FIG. 5, an REG bundle 505 may be configured to include two REGs 510. That is, the REG bundle 505 may have an REG bundle shape that includes two REGs 510 in two symbols in the time domain (e.g., for a CORESET 530 in two symbols).

As shown by reference number 515, the REG bundles 505 may be written into a matrix 520 according to an interleaving configuration. For example, the interleaving configuration may indicate a number of rows that are to be used for interleaving. As shown, the number of rows may be six (e.g., the matrix 520 may include six rows). The REG bundles 505 may be written into the matrix 520 by row, such that the REG bundles 505 are written to a first row of the matrix 520 first, a second row of the matrix 520 second, and so forth. The matrix 520 may also be referred to as an interleaver.

As shown by reference number 525, the REG bundles 505 may be read out of the matrix 520, in REG bundle units, and mapped to one or more CCEs (CCE1 through CCE8) of a CORESET 530. For example, the REG bundles 505 may be read out of the matrix 520, by column, and mapped to the one or more CCEs. As an example, REG bundles 505 in a first column of the matrix 520 may be mapped to the one or more CCEs first, REG bundles 505 in a second column may be mapped to the one or more CCEs second, and so forth. As an example, a CCE may be configured to include six REGs 510 (i.e., three REG bundles 505 of two REGs 510).

As shown by reference number 535, the mapping of the REG bundles 505 to the one or more CCEs of the CORESET 530 may result in an interleaving of the REG bundles 505 in the plurality of CCEs of the CORESET 530. An interleaved CORESET 530 may have CCE-to-REG mapping such that adjacent CCEs are mapped to scattered REG bundles in the frequency domain (e.g., adjacent CCEs are not mapped to consecutive REG bundles of the CORESET 530). Additionally, REGs 510 of a given CCE may be mapped to non-adjacent resources (e.g., RBs) in the frequency domain. This improves communication performance of a communication (e.g., a PDCCH communication) that is received via the CORESET 530 (e.g., because of the improved frequency domain diversity of the CCEs).

As indicated above, FIG. 5 is provided as an example. Other examples may differ from what is described with respect to FIG. 5.

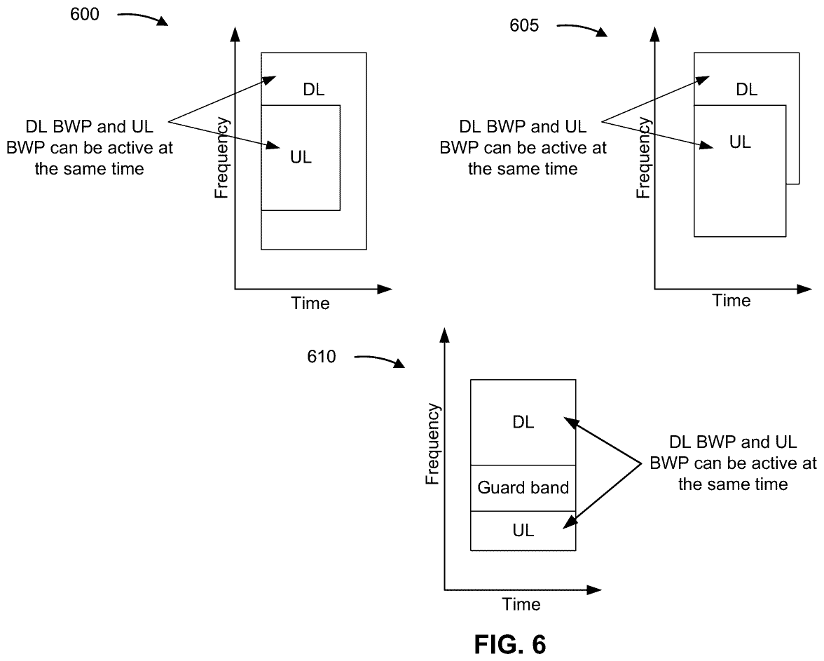

FIG. 6 is a diagram illustrating examples 600, 605, and 610 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol). For example, for full-duplex communications, a downlink BWP and an uplink BWP may be active at the same time (e.g., using the same, or at least partially overlapping, time domain resources).

As shown in FIG. 6, examples 600 and 605 show examples of in-band full-duplex (IBFD) communication. In IBFD, a UE may transmit an uplink communication to a network node and receive a downlink communication from the network node on the same time and frequency resources. As shown in example 600, in a first example of IBFD, the time and frequency resources for uplink communication may fully overlap with the time and frequency resources for downlink communication. As shown in example 605, in a second example of IBFD, the time and frequency resources for uplink communication may partially overlap with the time and frequency resources for downlink communication.

As further shown in FIG. 6, example 610 shows an example of sub-band full-duplex (SBFD) communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

As indicated above, FIG. 6 is provided as an example. Other examples may differ from what is described with respect to FIG. 6.

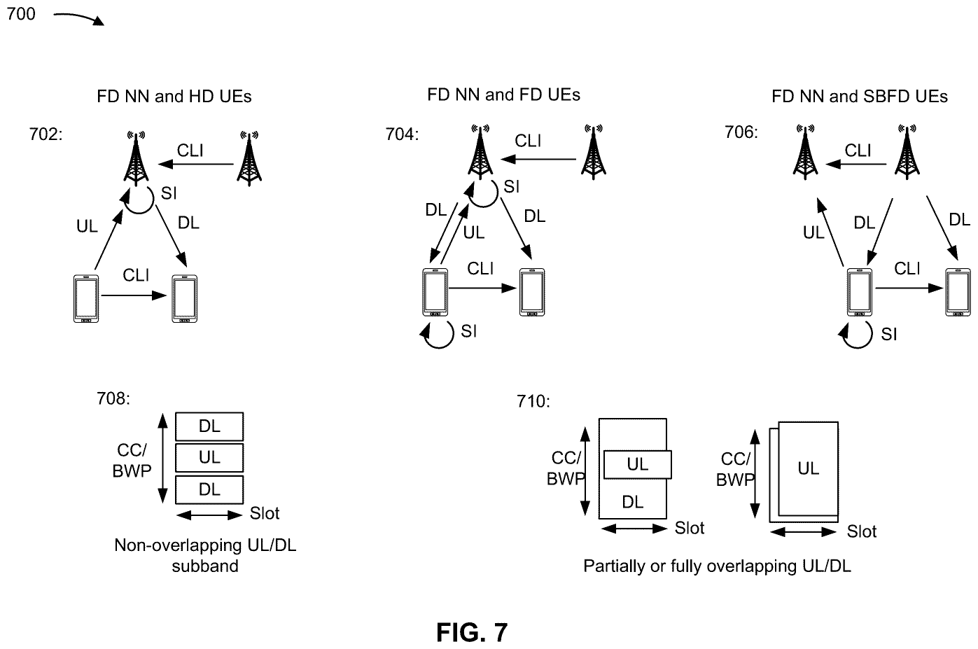

FIG. 7 is a diagram illustrating examples 700 of full-duplex communications, in accordance with the present disclosure.

As shown by reference number 702, a full-duplex network node (NN) may communicate with half-duplex UEs. The full-duplex network node may be subjected to cross-link interference (CLI) from another full-duplex network node (e.g., inter-network node CLI). The full-duplex network node may experience self-interference (SI). The full-duplex network node may receive an uplink transmission from a first half-duplex UE, and the full-duplex network node may transmit a downlink transmission to a second half-duplex UE. The second half-duplex UE may be subjected to CLI from the first half-duplex UE (e.g., inter-UE CLI), where the CLI may be based at least in part on the uplink transmission from the first half-duplex UE.

As shown by reference number 704, a full-duplex network node may communicate with full-duplex UEs. The full-duplex network node may be subjected to CLI from another full-duplex network node. The full-duplex network node may experience SI. The full-duplex network node may transmit a downlink transmission to a first full-duplex UE, and the full-duplex network node may receive an uplink transmission from the first full-duplex UE at the same time as the downlink transmission. The full-duplex network node may transmit a downlink transmission to a second full-duplex UE. The second half-duplex UE may be subjected to CLI from the first half-duplex UE, where the CLI may be based at least in part on the uplink transmission from the first full-duplex UE. The first UE may experience SI.

As shown by reference number 706, a first full-duplex network node, which may be associated with multiple TRPs, may communicate with SBFD UEs. The first full-duplex network node may be subjected to CLI from a second full-duplex network node. The first full-duplex network node may receive an uplink transmission from a first SBFD UE. The second full-duplex network node may transmit downlink transmissions to both the first SBFD UE and a second SBFD UE. The second SBFD UE may be subjected to CLI from the first SBFD UE, where the CLI may be based at least in part on the uplink transmission from the first SBFD UE. The first SBFD UE may experience SI.

As shown by reference number 708, an SBFD slot may be associated with a non-overlapping uplink/downlink sub-bands. Within a component carrier bandwidth and/or a BWP, an uplink resource may be in between, in a frequency domain, a first downlink resource and a second downlink resource. The first downlink resource, the second downlink resource, and the uplink resource may all be associated with the same time domain resources.

As shown by reference number 710, a slot (e.g., a full-duplex slot) may be associated with partially or fully overlapping uplink/downlink resources. Within a component carrier bandwidth and/or a BWP, an uplink resource may fully or partially overlap with a downlink resource.

As indicated above, FIG. 7 is provided as an example. Other examples may differ from what is described with regard to FIG. 7.

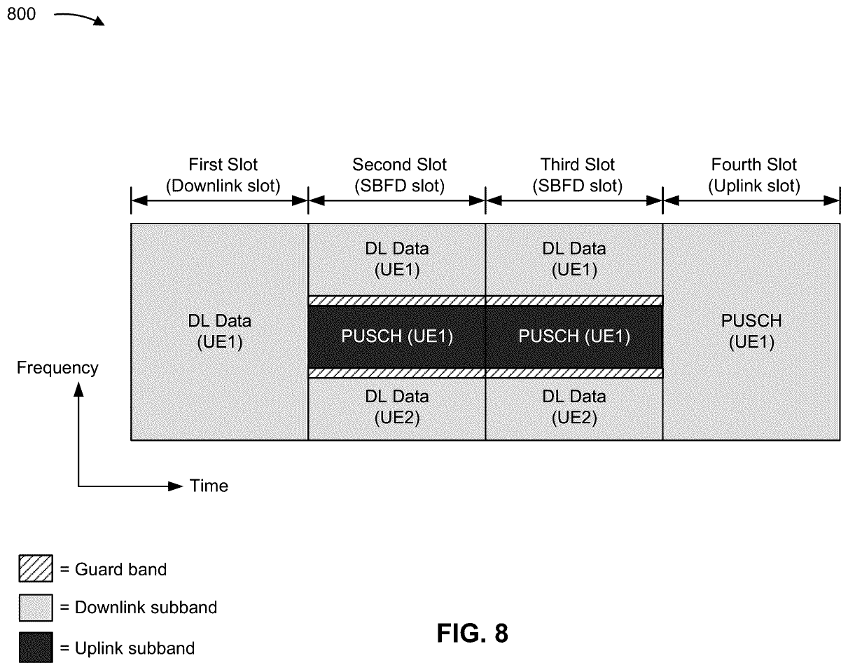

FIG. 8 is a diagram illustrating an example 800 of an SBFD slot format, in accordance with the present disclosure. An SBFD slot format may be a slot format that is defined as a “downlink and uplink” slot (e.g., a “D+U” slot). The downlink and uplink slot may be a slot in which a band is used for both uplink and downlink transmissions. The downlink and uplink transmissions may occur in overlapping bands (e.g., IBFD) or in adjacent bands (e.g., SBFD). In a given downlink and uplink slot symbol, a half-duplex UE may either transmit in an uplink band or receive in a downlink band. In a given downlink and uplink slot symbol, a full-duplex UE may transmit in an uplink band and/or receive in a downlink band (e.g., in the same slot). The downlink and uplink slot may include downlink only symbols, uplink only symbols, or full-duplex symbols.

As shown in FIG. 8, a first slot may be associated with downlink data for a first UE. A second slot (e.g., an SBFD slot) may be associated with downlink data for the first UE, uplink data for the first UE, and downlink data for a second UE. The uplink data may be associated with a physical uplink shared channel (PUSCH) transmission. A third slot (e.g., an SBFD slot) may be associated with downlink data for the first UE, uplink data for the first UE, and downlink data for the second UE. A fourth slot may be associated with uplink data for the first UE.

As indicated above, FIG. 8 is provided as an example. Other examples may differ from what is described with regard to FIG. 8.

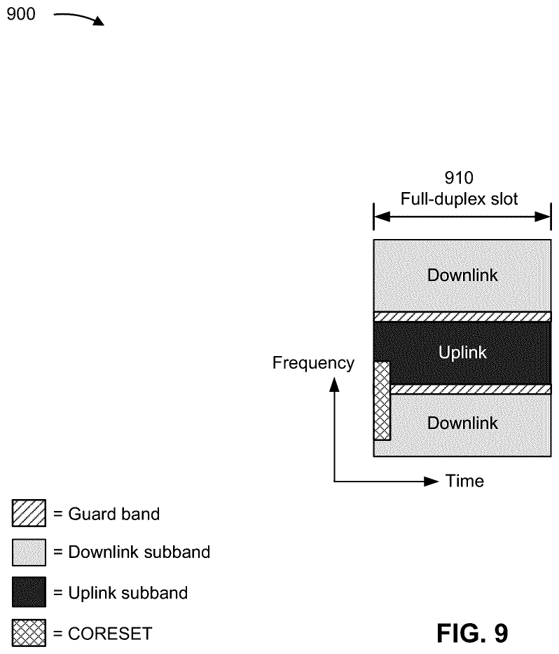

FIG. 9 is a diagram illustrating an example 900 of a control channel monitoring occasion included in a full-duplex slot 910, in accordance with the present disclosure. As shown in FIG. 9, the full-duplex slot 910 may be an SBFD slot (e.g., similar to the SBFD slot described above in connection with FIG. 8). In other examples, the full-duplex slot 910 may be associated with IBFD resources (e.g., where the uplink resources and downlink resources of the slot are at least partially overlapping in the frequency domain).

A control channel monitoring occasion (e.g., a PDCCH monitoring occasion) may be configured to occur during the full-duplex slot 910. For example, a CORESET may be configured (e.g., by a CORESET configuration and/or a search space configuration, in a similar manner as described above in connection with FIG. 4) in the full-duplex slot 910. A UE may be configured to monitor resources associated with the CORESET to receive a downlink communication (e.g., a PDCCH communication).

However, in some cases, the resources (e.g., frequency domain resources) associated with a configured CORESET may at least partially overlap with uplink resources (e.g., an uplink subband) and/or with resources associated with a guard band of the full-duplex slot 910. For example, in some cases, the UE and the network node may switch slot patterns and/or slot types used over time. For example, a first configuration may indicate a first slot format pattern (sometimes called a time division duplex (TDD) pattern) associated with a half-duplex mode or a full-duplex mode. The first slot format pattern may include a number of downlink slots, a number of flexible slots, and/or a number of uplink slots. The first slot format pattern may repeat over time. In some examples, a network node may indicate, to the UE, that a second slot format pattern is to be used (e.g., using RRC signaling, MAC-CE signaling, and/or DCI signaling). Therefore, slot format patterns used by the UE and the network node may change over time. However, a CORESET configuration may be a static configuration (e.g., an RRC configuration) that does not change over time (or that changes infrequently over time). As a result, a CORESET configuration and/or a search space configuration may result in monitoring occasions that occur in a first slot type (e.g., a half-duplex slot) at one time and that occur in a second slot type (e.g., a full-duplex slot) at another time.

Therefore, the UE may be configured to monitor for downlink transmissions (e.g., in accordance with the CORESET configuration and/or the search space configuration) using frequency domain resources that are also configured for transmitting uplink transmissions (e.g., in accordance with the full-duplex slot configuration). In other words, one or more RBs of the full-duplex slot 910 may be configured for both uplink transmissions and downlink transmissions. In some cases, the UE may not be capable of transmitting and receiving using the same time domain and frequency domain resources. In such examples, it may be unclear how the UE is to handle the resources that are configured for both uplink transmissions and downlink transmissions. For example, the UE may use the resources for uplink transmissions, thereby increasing a likelihood that the UE is unable to detect, decode, and/or receive a control channel communication (e.g., a PDCCH communication) that is transmitted via the CORESET. Alternatively, the UE may use the resources for downlink transmissions (e.g., increasing a likelihood that the UE is able to detect, decode, and/or receive a control channel communication), thereby reducing resources available for uplink transmissions by the UE, thereby reducing a throughput, reducing performance, and/or increasing latency, among other examples, associated with the uplink transmissions.

In some cases, the UE may monitor a subset of frequency domain resources from a set of frequency domain resources of the CORESET (e.g., partial monitoring of the CORESET). For example, the UE may perform CCE-to-REG mapping and/or interleaving (e.g., in a similar manner as described elsewhere herein) for the CORESET. The UE may identify PDCCH candidates that are mapped to frequency resources (e.g., RBs) that at least partially overlap with uplink resources and/or guard band resources of the full-duplex slot 910. The UE may refrain from monitoring the PDCCH candidates that are mapped to frequency resources that at least partially overlap with uplink resources and/or guard band resources of the full-duplex slot 910. However, this consumes significant processing resources, memory resources, and/or power resources, among other examples, associated with performing CCE-to-REG mapping and/or interleaving and identifying the PDCCH candidates that are mapped to frequency resources that at least partially overlap with uplink resources and/or guard band resources of the full-duplex slot 910.

Some techniques and apparatuses described herein enable enhanced CORESET configurations for full-duplex operations. In some aspects, a UE and/or a network node may be enabled to handle CORESET configurations that are associated with frequency domain resources that at least partially overlap with uplink resources (and/or guard band resources) of a full-duplex slot, such as an SBFD slot. For example, the UE and/or the network node may adapt a CORESET configuration based at least in part on a slot type of a slot in which a monitoring occasion associated with the CORESET occurs. In some aspects, the UE and/or the network node may adapt a CORESET configuration to cause the CORESET to be associated with fully configured frequency domain resources (e.g., all configured CCEs) for half-duplex slots and to be associated with frequency domain resources (e.g., CCEs) that do not overlap with uplink resources (and/or guard band resources) for full-duplex slots.

As a result, the UE and the network node may be enabled to deal with CORESET resources that overlap with uplink resources (and/or guard band resources) of full-duplex slots in an efficient and synchronized manner. For example, this ensures that the UE and the network node are synchronized on how the overlapping resources will be utilized (e.g., for uplink transmissions or downlink transmission). Additionally, adapting the CORESET configuration (e.g., prior to performing PDCCH candidate-to-CCE mapping and/or interleaving) reduces processing resources, memory resources, and/or power resources, among other examples, that would have otherwise been used to perform PDCCH-candidate-to-CCE mapping and/or interleaving and to identify PDCCH candidates that are mapped to frequency resources that at least partially overlap with uplink resources and/or guard band resources of the full-duplex slot. As another example, this increases network resource utilization by enabling a full-duplex slot type to be used by the UE and the network node (e.g., by using both a downlink BWP and an uplink BWP simultaneously instead of only the downlink BWP or the uplink BWP).

In some aspects, a CORESET configuration of the CORESET may indicate a set of frequency domain resources associated with the CORESET (e.g., a set of CCEs and/or a set of RBs). The UE and/or the network node may adapt the CORESET configuration such that the CORESET configuration is associated with the set of frequency domain resources if a slot type is a half-duplex slot type, or associated with a subset of frequency domain resources, of the set of frequency domain resources, if the slot type is a full-duplex slot type (e.g., where the subset of frequency domain resources do not overlap, in the frequency domain, with uplink resources or guard band resources of the full-duplex slot). In other words, the UE and/or the network node may implicitly adapt the CORESET configuration based at least in part on the slot type. In other words, for downlink slots, all CCEs configured for a CORESET may be valid and available. For full-duplex slots, CCEs that at least partially overlap, in the frequency domain, with uplink resources or guard band resources may be invalid and/or unavailable, thereby enabling a single CORESET configuration to be adapted over time (e.g., reducing an overhead associated with the CORESET configuration) while ensuring that frequency domain resources (e.g., CCEs and/or RBs) of the CORESET that overlap, in the frequency domain, with uplink resources or guard band resources of a full-duplex slot are not used by the UE and/or the network node for control channel communications.

In some aspects, a search space may be configured with a plurality of CORESET groups. For example, the search space may be configured with a first CORESET group (e.g., associated with one or more configured CORESETs) and a second CORESET group (e.g., associated with one or more configured CORESETs). The first CORESET group may be associated with a first slot type (e.g., half-duplex slots) and the second CORESET group may be associated with a second slot type (e.g., full-duplex slots). The UE and the network node may switch an active CORESET group based at least in part on the slot type of a slot in which a PDCCH monitoring occasion occurs. For example, CORESET(s) included in the second CORESET group may be associated with frequency domain resources (e.g., CCEs and/or RBs) that do not overlap, in the frequency domain, with uplink resources or guard band resources of a full-duplex slot. If a slot in which a PDCCH monitoring occasion occurs (e.g., as indicated by a search space configuration associated with the search space) is a half-duplex slot, then the UE and the network node may use a CORESET included in the first CORESET group for the PDCCH monitoring occasion. If a slot in which a PDCCH monitoring occasion occurs (e.g., as indicated by a search space configuration associated with the search space) is a full-duplex slot, then the UE and the network node may use a CORESET included in the second CORESET group for the PDCCH monitoring occasion. This conserves processing resources, memory resources, and/or power resources, among other examples, associated with identifying frequency domain resources of a CORESET that at least partially overlap with uplink resources or guard band resources of a full-duplex slot, while still ensuring that frequency domain resources (e.g., CCEs and/or RBs) of a CORESET that overlap, in the frequency domain, with uplink resources or guard band resources of a full-duplex slot are not used by the UE and/or the network node for control channel communications (e.g., for PDCCH monitoring).

As indicated above, FIG. 9 is provided as an example. Other examples may differ from what is described with regard to FIG. 9.

FIG. 10 is a diagram of an example 1000 associated with enhanced CORESET configurations for full-duplex operations, in accordance with the present disclosure. As shown in FIG. 10, one or more network nodes (NNs) 110 (e.g., a base station, a CU, a DU, and/or an RU) may communicate with a UE 120. In some aspects, the network node(s) 110 and the UE 120 may be part of a wireless network (e.g., wireless network 100). The UE 120 and the network node(s) 110 may have established a wireless connection prior to operations shown in FIG. 10.

In some aspects, actions described herein as being performed by a network node 110 may be performed by a plurality of different network nodes. For example, configuration actions may be performed by a first network node (for example, a CU or a DU), and radio communication actions may be performed by a second network node (for example, a DU or an RU).

As used herein, the network node 110 “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown by reference number 1005, the UE 120 may transmit, and the network node 110 may receive, a capability report. The capability report may indicate UE support for one or more operations described herein. For example, the capability report may indicate that the UE 120 supports enhanced CORESET configurations for full-duplex operations, as described herein. In some aspects, the capability report may indicate that the UE 120 supports adapting CORESET configurations according to slot types, as described in more detail elsewhere herein. For example, the capability report may indicate that the UE 120 supports modifying available frequency domain resources (e.g., CCEs and/or RBs) of a CORESET based at least in part on a slot type in which a monitoring occasion occurs, as described in more detail elsewhere herein. Additionally, or alternatively, the capability report may indicate that the UE 120 supports being configured with a search space that is associated with a plurality of CORESETs (e.g., a plurality of CORESET groups) for respective slot types. In some aspects, the capability report may indicate that the UE 120 supports receiving indications of different slot types. For example, the capability report may indicate that the UE 120 is capable of being configured with different slot types, such as half-duplex slots, full-duplex slots, IBFD slots, and/or SBFD slots, among other examples.

In some aspects, the network node 110 may configure the UE 120 to perform one or more operations described herein based at least in part on the capability report. For example, the network node 110 may configure the UE 120 with an enhanced CORESET configuration for full-duplex operations based at least in part on the capability report indicating that the UE 120 supports the enhanced CORESET configuration for full-duplex operations.

As shown by reference number 1010, the network node 110 may transmit, and the UE 120 may receive, configuration information. In some aspects, the UE 120 may receive the configuration information via one or more of system information signaling, RRC signaling, one or more MAC control elements (MAC-CEs), and/or DCI, among other examples. In some aspects, the configuration information may include an indication of one or more configuration parameters (e.g., stored by the UE 120 and/or previously indicated by the network node 110 or other network device) for selection by the UE 120, and/or explicit configuration information for the UE 120 to use to configure itself, among other examples.

In some aspects, the configuration information may indicate that the UE 120 is to use a CORESET configuration, for a monitoring occasion of a control channel (e.g., a PDCCH) that occurs in a slot, that is based at least in part on a slot type associated with the slot. For example, the configuration information may indicate that the UE 120 is to adapt the CORESET configuration based at least in part on the slot type. For example, the UE 120 may use a first CORESET configuration for a first slot type (e.g., a half-duplex slot type) and a second CORESET configuration for a second slot type (e.g., a full-duplex slot type). As used herein, “half-duplex slot type” may refer to a slot type associated with one-way communications (e.g., with only uplink transmissions or with only downlink transmissions). As used herein, “full-duplex slot type” may refer to a slot type in which full-duplex communications may occur (e.g., IBFD communications and/or SBFD communications). An SBFD slot type (e.g., similar to the slot format depicted and described in connection with FIG. 8) may be an example of a full-duplex slot type.

In some aspects, the configuration information may indicate a slot pattern and/or a slot format pattern (e.g., a TDD pattern). For example, the configuration information may indicate that full-duplex slots are configured and/or activated. The configuration information may indicate a pattern or a timing of the different slot types, thereby enabling the UE 120 to determine when a full-duplex slot and/or an SBFD slot is to occur. In some aspects, operations described herein may be performed based at least in part on full-duplex slots and/or SBFD slots being configured and/or activated for the UE 120. For example, the UE 120 may perform one or more operations described herein based at least in part on the network node 110 indicating that full-duplex slots and/or SBFD slots are being configured and/or activated for the UE 120.

In some aspects, the configuration information may indicate that the UE 120 is to adapt or modify available frequency domain resources (e.g., CCEs and/or RBs) of a CORESET from configured frequency domain resources of the CORESET based at least in part on the slot type. For example, the configuration information may indicate that the UE 120 is to use the configured frequency domain resources of the CORESET for half-duplex slot types. The configuration information may indicate that the UE 120 is to use modified frequency domain resources of the CORESET for full-duplex slot types. For example, the modified frequency domain resources may include frequency domain resources (e.g., CCEs and/or RBs) of the configured frequency domain resources of the CORESET that do not overlap with uplink resources and/or guard band resources of a full-duplex slot. In other words, the configuration information may indicate that frequency domain resources (e.g., CCEs and/or RBs) of the configured frequency domain resources of the CORESET that at least partially overlap, in the frequency domain, with uplink resources and/or guard band resources of a full-duplex slot are to be unavailable during full-duplex slots. For full-duplex slots, the configuration information may indicate that PDCCH candidate-to-CCE mapping operations and/or interleaving operations are to be performed only using available frequency domain resources (e.g., CCEs and/or RBs) of a CORESET (e.g., and not using frequency domain resources of the CORESET that at least partially overlap, in the frequency domain, with uplink resources and/or guard band resources of a full-duplex slot type).

“Available” frequency domain resources may refer to frequency domain resources that are available to be used (e.g., to be monitored) by the UE 120 for a full-duplex slot type. For example, “available” frequency domain resources of a CORESET in a full-duplex slot may refer to frequency domain resources (e.g., CCEs and/or RBs) of configured frequency domain resources of the CORESET that do not overlap, in the frequency domain, with uplink resources and/or guard band resources of the full-duplex slot.

In some aspects, the configuration information may indicate that the UE 120 is to switch an active CORESET group based at least in part on the slot type in which a monitoring occasion associated with the CORESET occurs. For example, the configuration information may indicate a search space configuration. The search space configuration may be associated with a plurality of CORESET groups. For example, the search space configuration may indicate that a search space is associated with a first CORESET group and a second CORESET group. Although examples may be described herein using two CORESET groups, more than two CORESET groups may be configured for a given search space. A CORESET group may include one or more CORESETs. In some aspects, a CORESET group may include a single CORESET. The CORESET groups may be associated with respective slot types. For example, the configuration information may indicate that the first CORESET group is associated with a first slot type and that the second CORESET group is associated with a second slot type. For example, the configuration information may link a CORESET (e.g., a CORESET configuration) to a CORESET group (e.g., a field or information element in a CORESET configuration may indicate a CORESET group associated with the CORESET).

As an example, the configuration information may indicate that the first CORESET group is associated with a full-duplex slot type and that the second CORESET group is associated with a half-duplex slot type. In such examples, the first CORESET group may be associated with one or more CORESETs that include frequency domain resources that do not overlap (e.g., in the frequency domain) with uplink resources and/or guard band resources of the full-duplex slot type. The configuration information may indicate that the UE 120 is to switch an active CORESET group to the CORESET group that corresponds to the slot type of a slot in which a monitoring occasion for the search space occurs.

In some aspects, the configuration information may indicate one or more CORESET configurations. A CORESET configuration may configure similar information as described above in connection with FIG. 4. For example, a CORESET configuration may include a ControlResourceSet RRC information element (e.g., as defined, or otherwise fixed, by a wireless communication standard, such as the 3GPP). The CORESET configuration may indicate frequency domain resources associated with the CORESET. For example, the CORESET configuration information may include an indication of RBs that are associated with the CORESET. As an example, the CORESET configuration information may include a bitmap indicating RBs that are associated with the CORESET (e.g., in a frequencyDomainResources information element of the CORESET configuration). For example, the bitmap may include N bits, where each bit represents 6 REGs (e.g., each bit represents 6 RBs and/or 1 CCE). The bitmap may indicate which RBs, included in a configured BWP, are to be associated with the CORESET. The CORESET configuration information may include an indication of a CCE-to-REG mapping type (e.g., interleaved or non-interleaved). The CORESET configuration information may include additional information associated with the CORESET (e.g., as defined, or otherwise fixed, by a wireless communication standard, such as the 3GPP), such as an aggregation level, an RB offset value, a CORESET pool index, an REG bundle size, and/or an interleaver size, among other examples.

The configuration information may indicate one or more search space configurations (e.g., via a SearchSpace RRC information element). For example, the search space configuration may indicate a CORESET associated with the search space (e.g., a CORESET ID associated with the search space), a monitoring slot periodicity and offset (e.g., indicating slots in which monitoring occasions associated with the search space occur), a duration (e.g., a number of slots in each monitoring occasion), an aggregation level, and/or a number of PDCCH candidates for each aggregation level, among other examples. For example, the monitoring slot periodicity and offset may define a periodicity and offset of the search space. In some aspects, the search space configuration may indicate one or more CORESET groups associated with the search space. For example, the search space may be configured to be associated with a plurality of CORESETs and/or a plurality of CORESET groups. For example, previously, a search space may have only been associated with a single CORESET. The network node 110 may configure the search space with a plurality of CORESETs and/or a plurality of CORESET groups for enhanced CORESET configurations for full-duplex operations, as described herein.

In some aspects, the search space configuration may indicate slot types associated with respective CORESETs and/or respective CORESET groups that are associated with the search space. For example, the search space configuration may indicate that a first CORESET group is associated with a first slot type e.g., full-duplex slots, such as SBFD slots) and that a second CORESET group is associated with a second slot type (e.g., half-duplex slots or downlink slots). The network node 110 may configure CORESET(s) included in the first CORESET group such that frequency domain resources of the CORESET(s) do not overlap, in the frequency domain, with uplink resources and/or guard band resources of the full-duplex slot type. In some aspects, the search space configuration may indicate CORESETs (e.g., CORESET IDs) that are associated with respective CORESET groups that are associated with the search space.

In some aspects, a search space configured with a plurality of CORESETs and/or a plurality of CORESET groups (e.g., for enhanced CORESET configurations for full-duplex operations) may be a UE-specific search space (USS). This enables other UEs that are not capable of detecting some (or all) full-duplex slot types (e.g., legacy UEs) to be configured with a CSS and/or another USS, while also enabling UEs that are capable of detecting some (or all) full-duplex slot types to be configured with the enhanced search space configuration (e.g., that is associated with a plurality of CORESETs and/or a plurality of CORESET groups). In other words, in some aspects, operations described herein for the enhanced CORESET and/or search space configurations may be restricted to CORESETs and/or search spaces associated with USSs.

The UE 120 may configure itself based at least in part on the configuration information. In some aspects, the UE 120 may be configured to perform one or more operations described herein based at least in part on the configuration information.

In some aspects, the UE 120 and/or the network node 110 may determine configurations of a CORESET for respective slot types. For example, the UE 120 and/or the network node 110 may determine a first configuration of the CORESET for a half-duplex slot type and a second configuration of the CORESET for a full-duplex slot type (e.g., for a SBFD slot type). The first configuration and the second configuration may be associated with different frequency domain resources (e.g., different RBs and/or different CCEs). For example, the first configuration may be associated with a set of frequency domain resources (e.g., a set of RBs and/or a set of CCEs) and the second configuration may be associated with a subset of frequency domain resources from the set of frequency domain resources (e.g., where the subset of frequency domain resources do not overlap, in the frequency domain, with uplink resources and/or guard band resources of the full-duplex slot type). In some aspects, the first configuration may be associated with a first CORESET or a first CORESET group of a search space and the second configuration may be associated with a second CORESET or a second CORESET group of the search space.

For example, as shown by reference number 1015, the network node 110 may determine a CORESET configuration associated with a full-duplex slot type. Similarly, as shown by reference number 1020, the UE 120 may determine the CORESET configuration associated with the full-duplex slot type. For example, the network node 110 and/or the UE 120 may implicitly (e.g., without direct signaling) adapt or modify frequency domain resources configured for the CORESET for the configuration associated with the full-duplex slot type. For example, CORESET configuration information (e.g., indicated by the configuration information) may indicate a set of frequency domain resources associated with the CORESET. The set of frequency domain resources may include one or more CCEs and/or one or more RBs. The UE 120 and/or the network node 110 may determine that the CORESET configuration associated with the full-duplex slot type includes a subset of frequency domain resources of the set of frequency domain resources. In other words, a configuration of the CORESET that is based at least in part on a slot type may be associated with the set of frequency domain resources if the slot type is the half-duplex slot type, or the subset of frequency domain resources, of the set of frequency domain resources, if the slot type is the full-duplex slot type.

For example, the UE 120 and/or the network node 110 may identify frequency domain resources, of the set of frequency domain resources configured for the CORESET, that at least partially overlap, in the frequency domain, with uplink resources and/or guard band resources associated with the full-duplex slot type (e.g., indicated by a slot format or a slot structure configuration). For example, the full-duplex slot type may include first one or more subbands associated with downlink communications, second one or more subbands associated with uplink communications, and/or one or more guard bands, among other examples. The subset of frequency domain resources may include frequency domain resources that do not overlap in the frequency domain with the second one or more subbands (e.g., uplink subbands) and/or the one or more guard bands.

For example, the UE 120 and/or the network node 110 may identify a first subset of frequency domain resources, of the set of frequency domain resources, that do not overlap in the frequency domain with uplink resources and/or guard band resources of the full-duplex slot type. The UE 120 and/or the network node 110 may identify a second subset of frequency domain resources, of the set of frequency domain resources, that at least partially overlap in the frequency domain with uplink resources and/or guard band resources of the full-duplex slot type. The configuration of the CORESET that is associated with the full-duplex slot type (e.g., that is based at least in part on the slot type being the full-duplex slot type) may be associated with the first subset of frequency domain resources being available (or valid) for the CORESET, and the second subset of frequency domain resources being unavailable (or invalid) for the CORESET. In other words, the UE 120 and/or the network node 110 may adapt or modify available CCEs associated with a CORESET such that CCEs, configured for the CORESET, that at least partially overlap, in the frequency domain, with uplink resources and/or guard band resources of the full-duplex slot type are unavailable during a full-duplex slot (e.g., during an SBFD slot).

For example, as described elsewhere herein, the CORESET configuration (e.g., indicated by the configuration information and/or an RRC configuration) may indicate frequency domain resources (e.g., RBs) associated with the CORESET. For example, the CORESET configuration may indicate a bitmap indicating the frequency domain resources (e.g., RBs) associated with the CORESET (e.g., in a frequencyDomainResources information element of the CORESET configuration). Each bit in the bitmap may correspond to a CCE (e.g., may correspond to 6 RBs). For example, the bitmap may be {0,0,0,0,1,1, 1, 1, 1, 1, 1, 1,0,0,0}, where a “0” indicates that a CCE (or RBs) corresponding to the bit is not included in the CORESET and a “1” indicates that a CCE (or RBs) corresponding to the bit is included in the CORESET.

The UE 120 and/or the network node 110 may identify that S CCEs included in the CORESET at least partially overlap, in the frequency domain, with uplink resources and/or guard band resources of the full-duplex slot type. Therefore, the UE 120 and/or the network node 110 may adapt or modify the bitmap to change the value associated with bits corresponding to the S CCEs. For example, the S CCEs may be a last three CCEs indicated by the bitmap as being included in the CORESET. Therefore, the UE 120 and/or the network node 110 may modify the bitmap to be {0,0,0,0,1,1,1,1,1,0,0,0,0,0,0} (e.g., with the modified bits indicated by italics for emphasis only). The UE 120 and/or the network node 110 may store the modified bitmap for use when a monitoring occasion associated with the CORESET occurs during a full-duplex slot. The UE 120 and/or the network node 110 may use the configured bitmap (e.g., before the modification) when a monitoring occasion associated with the CORESET occurs during a half-duplex slot.

As another example, the UE 120 and/or the network node 110 may determine the CORESET configuration associated with the full-duplex slot type based at least in part on a search space configuration. For example, the search space configuration may indicate a plurality of CORESETs and/or a plurality of CORESET groups for respective slot types. The UE 120 and/or the network node 110 may identify a CORESET and/or a CORESET group that is associated with the full-duplex slot type. The UE 120 and/or the network node 110 may determine that the CORESET and/or a CORESET included in the CORESET group, configured for the search space, that is associated with the full-duplex slot type is to be used when a monitoring occasion associated with the search space occurs during a full-duplex slot. Similarly, the UE 120 and/or the network node 110 may determine that a CORESET and/or a CORESET included in a CORESET group, configured for the search space, that is associated with the half-duplex slot type is to be used when a monitoring occasion associated with the search space occurs during a half-duplex slot.

As shown by reference number 1025, the network node 110 may transmit a control channel communication (e.g., a PDCCH communication). The network node 110 may transmit the control channel communication during a slot. For example, a CORESET configuration and/or a search space configuration may indicate a timing of the transmission of the control channel communication. The timing (e.g., indicated by a slot periodicity and offset indicated by the search space configuration) may indicate that the transmission is to occur (or that the transmission is permitted to occur if the network node 110 has a communication to transmit) during the slot (e.g., during a monitoring occasion configured to occur during the slot).

As shown by reference number 1030, the UE 120 may monitor resources associated with a CORESET configuration that is based on a slot type associated with the slot. For example, if the slot type is a half-duplex slot, then the UE 120 may monitor resources associated with a CORESET configuration that is associated with a half-duplex slot type. Alternatively, if the slot type is a full-duplex slot, then the UE 120 may monitor resources associated with a CORESET configuration that is associated with a full-duplex slot type.

For example, the search space associated with the monitoring occasion may be associated with CORESETs and/or CORESET groups associated with respective slot types. For example, the search space may be associated with a first CORESET that is associated with a first slot type, a second CORESET that is associated with a second slot type, and so on. In some aspects, the search space may be associated with a first CORESET that is associated with a full-duplex slot type and a second CORESET that is associated with a half-duplex slot type. The UE 120 may monitor resources associated with the first CORESET if the slot type (e.g., in which the monitoring occasion occurs) is the full-duplex slot type. Alternatively, the UE 120 may monitor resources associated with the second CORESET if the slot type (e.g., in which the monitoring occasion occurs) is the half-duplex slot type. For example, the first CORESET may be associated with a first set of frequency domain resources and the second CORESET may associated with a second set of frequency domain resources. The first set of frequency domain resources may not overlap, in the frequency domain, with uplink resources or guard band resources of the full-duplex slot type (e.g., as configured by the network node 110 or another network node).

As another example, the search space may be associated with a first CORESET group that is associated with a first slot type, a second CORESET group that is associated with a second slot type, and so on. In some aspects, the search space may be associated with a first CORESET group that is associated with a full-duplex slot type and a second CORESET group that is associated with a half-duplex slot type. The UE 120 may identify or select a CORESET (e.g., resources to be monitored during the monitoring occasion associated with the search space) from the first CORESET group or the second CORESET group based at least in part on the slot type of the slot in which the monitoring occasion occurs. For example, the UE 120 may switch an active CORESET and/or an active CORESET group for the search space based at least in part on the slot type of the slot in which the monitoring occasion occurs. For example, the UE 120 may activate an active CORESET group, of the first CORESET group or the second CORESET group, based at least in part on the slot type (e.g., and the CORESET monitored by the UE 120 for the monitoring occasion is included in the active CORESET group).

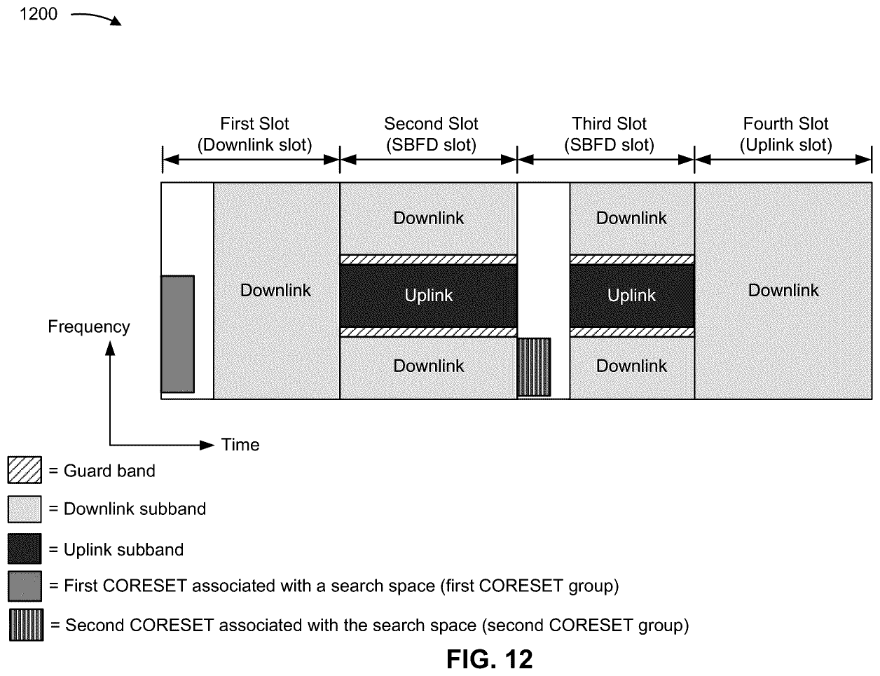

For example, if the slot type is the full-duplex slot type, then the first CORESET group may be the active CORESET group and the UE 120 may monitor resources associated with a CORESET included in the first CORESET group. If a future monitoring occasion associated with the CORESET occurs during a half-duplex slot, then the UE 120 may switch the active CORESET group to the second CORESET group. In such examples, the second CORESET group may be the active CORESET group and the UE 120 may monitor resources associated with a CORESET included in the second CORESET group. In other words, the UE 120 may switch (e.g., implicitly or without an explicit indication from the network node 110) an active CORESET group for a monitoring occasion associated with the search space based at least in part on the slot type, such that a CORESET group associated with half-duplex slots is active in half-duplex slots and a CORESET group associated with full-duplex slots is active in full-duplex slots (e.g., as depicted and described in more detail in connection with FIG. 12).

In some aspects, the UE 120 may use configured frequency domain resources for the CORESET for a first slot type (e.g., for half-duplex slots) or modified frequency domain resources for a second slot type (e.g., for full-duplex slots). For example, as described elsewhere herein, the UE 120 and/or the network node 110 may adapt or modify available frequency domain resources of a CORESET for full-duplex slots (e.g., for SBFD slots). For example, the UE 120 and/or the network node 110 may perform one or more operations associated with the CORESET using only a subset of frequency domain resources of a set of (configured) frequency domain resources if the slot type is the full-duplex slot type, or using the set of (configured) frequency domain resources if the slot type is the half-duplex slot type. For example, the one or more operations may include a PDCCH candidate mapping operation, and/or an interleaving operation, among other examples.

For example, the UE 120 and/or the network node 110 may map one or more PDCCH candidates to the subset of frequency domain resources (e.g., to available CCEs of the CORESET) if the slot type is the full-duplex slot type. Alternatively, the UE 120 and/or the network node 110 may map the one or more PDCCH candidates to the set of frequency domain resources (e.g., all configured CCEs of the CORESET) if the slot type is the half-duplex slot type. As another example, the UE 120 and/or the network node 110 may perform an interleaving operation using only the subset of frequency domain resources if the slot type is the full-duplex slot type. Alternatively, the UE 120 and/or the network node 110 may perform the interleaving operation using the set of frequency domain resources if the slot type is the half-duplex slot type. For example, the interleaving operation may be similar to the operation described in connection with FIG. 5, but the CCEs used in (or available for) the interleaving operation for the CORESET may be different for monitoring occasions that occur in different slot types.

In other words, PDCCH candidate mapping (e.g., PDCCH candidate-to-CCE mapping) for a given CORESET may be different for slots associated with different slot types (e.g., a first PDCCH-candidate-to-CCE mapping for the given CORESET may occur in half-duplex slots and a second PDCCH-candidate-to-CCE mapping for the given CORESET may occur in full-duplex slots). Similarly, interleaving for a given CORESET may be different for slots associated with different slot types (e.g., interleaving may be performed using different CCEs of the CORESET for monitoring occasions that occur in different slot types). This conserves processing resources, memory resources, and/or power resources, among other examples, that would have otherwise been used by the UE 120 and/or the network node 110 identifying PDCCH candidates that are associated with frequency domain resources that at least partially overlap, in the frequency domain, with uplink resources and/or guard band resources of a full-duplex slot after performing PDCCH candidate mapping and/or interleaving, among other examples.

The UE 120 may monitor resources associated with the CORESET (e.g., resources indicated by the configuration of the CORESET that is based at least in part on the slot type, as described elsewhere herein). The UE 120 may receive the control channel communication based at least in part on monitoring the CORESET.

As shown by reference number 1035, the UE 120 and the network node 110 may communicate based at least in part on the control channel communication. For example, the control channel communication may include DCI that schedules one or more communications. The UE 120 and the network node 110 may transmit and/or receive the one or more communications scheduled by the DCI.

As a result, the UE 120 and the network node 110 may be enabled to deal with CORESET resources that overlap with uplink resources (and/or guard band resources) of full-duplex slots in an efficient and synchronized manner. For example, this ensures that the UE 120 and the network node 110 are synchronized on how the overlapping resources will be utilized (e.g., for uplink transmissions or downlink transmission). Additionally, adapting the CORESET configuration (e.g., prior to performing PDCCH-candidate-to-CCE mapping and/or interleaving) conserves processing resources, memory resources, and/or power resources, among other examples, that would have otherwise been used to perform PDCCH-candidate-to-CCE mapping and/or interleaving and to identify PDCCH candidates that are mapped to frequency resources that at least partially overlap with uplink resources and/or guard band resources of the full-duplex slot. As another example, this increases network resource utilization by enabling a full-duplex slot type to be used by the UE 120 and the network node 110 (e.g., by using both a downlink BWP and an uplink BWP simultaneously instead of only the downlink BWP or the uplink BWP).

As indicated above, FIG. 10 is provided as an example. Other examples may differ from what is described with respect to FIG. 10.

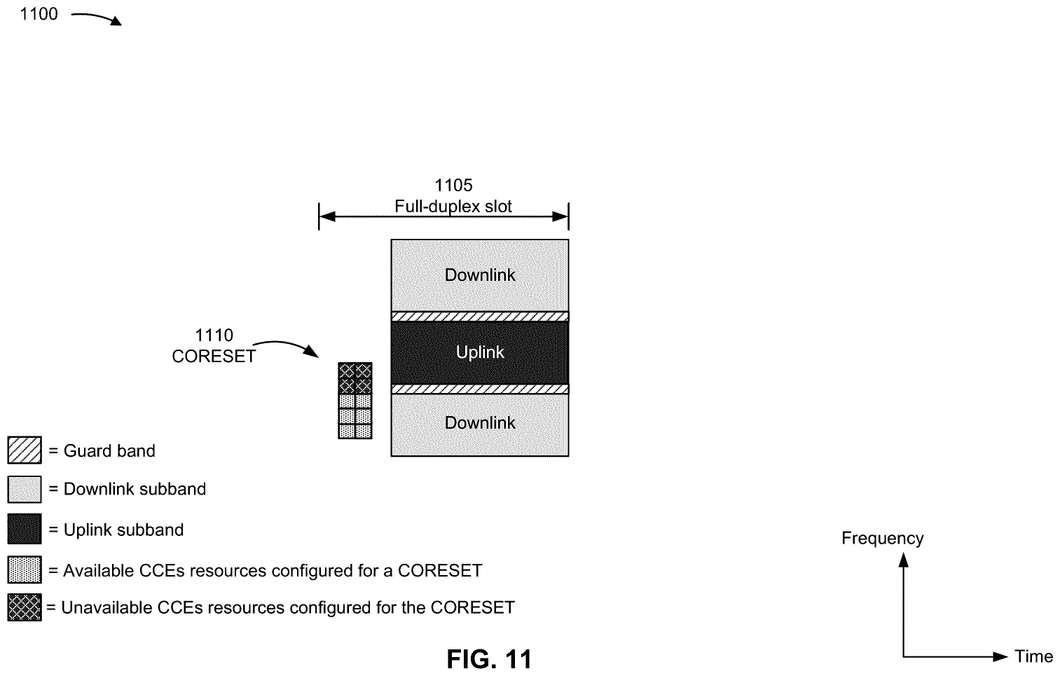

FIG. 11 is a diagram of an example 1100 associated with enhanced CORESET configurations for full-duplex operations, in accordance with the present disclosure. Example 1100 is associated with available frequency domain resources (e.g., available CCEs) for a CORESET in a full-duplex slot 1105. The full-duplex slot 1105 depicted in FIG. 11 may be an SBFD slot. However, the operations described herein may be similarly applied to other types of full-duplex slots, such as IBFD slots.

As shown in FIG. 11, a CORESET 1110 may be configured with one or more (e.g., a set of) frequency domain resources. For example, the CORESET 1110 may be configured (e.g., via an RRC configuration) with one or more CCEs in one or more symbols (e.g., 10 CCEs in 2 symbols as shown in FIG. 11). In some aspects, the CORESET 1110 may be included in the full-duplex slot 1105 (e.g., according to a slot pattern and a search space configuration associated with the CORESET 1110). As shown in FIG. 11, frequency domain resources of the CORESET 1110 may at least partially overlap in the frequency domain with uplink resources (e.g., an uplink subband) and/or guard band resources of the full-duplex slot 1105.

The UE 120 and/or the network node 110 may adapt or modify the available frequency domain resources (e.g., available CCEs) for the CORESET 1110 when a monitoring occasion associated with the CORESET 1110 occurs during a full-duplex slot type, such as the full-duplex slot 1105. For example, the UE 120 and/or the network node 110 may modify the frequency domain resources (e.g., available CCEs) for the CORESET 1110 such that frequency domain resources (e.g., CCEs) configured for the CORESET 1110 that at least partially overlap in the frequency domain with uplink resources (e.g., an uplink subband) and/or guard band resources of the full-duplex slot 1105 are unavailable during the full-duplex slot 1105. For example, as shown in FIG. 11, only CCEs that do not overlap in the frequency domain with uplink resources (e.g., an uplink subband) and/or guard band resources of the full-duplex slot 1105 are available during the full-duplex slot 1105. In other slots, such as half-duplex slots, other frequency domain resources (or all frequency domain resources) configured for the CORESET 1110 may be available depending on the slot type and/or slot format.

The UE 120 and the network node 110 may use the available frequency domain resources (e.g., the available CCEs) to perform PDCCH candidate mapping and/or interleaving, among other examples, for the CORESET 1110. The UE 120 may monitor the mapped and/or interleaved PDCCH candidates to attempt to detect and/or decode control channel communications (e.g., PDCCH communications) transmitted by the network node 110. This conserves processing resources, memory resources, and/or power resources, among other examples, that would have otherwise been used by the UE 120 and/or the network node 110 identifying PDCCH candidates that are associated with frequency domain resources that at least partially overlap, in the frequency domain, with uplink resources and/or guard band resources of the full-duplex slot 1105 after performing PDCCH candidate mapping and/or interleaving, among other examples.

As indicated above, FIG. 11 is provided as an example. Other examples may differ from what is described with respect to FIG. 11.

FIG. 12 is a diagram of an example 1200 associated with enhanced CORESET configurations for full-duplex operations, in accordance with the present disclosure. Example 1200 is associated with a search space that is associated with a plurality of CORESETs and/or a plurality of CORESET groups. For example, the search space may be associated with CORESETs or CORESET groups corresponding to respective slot types (e.g., a half-duplex slot type or a full-duplex slot type), as described elsewhere herein.

For example, the search space may be configured (e.g., in an RRC configuration) with a plurality of CORESETs and/or a plurality of CORESET groups. The configuration of the search space may indicate slot types corresponding to the plurality of CORESETs and/or the plurality of CORESET groups. The UE 120 and/or the network node may activate or switch an active CORESET and/or an active CORESET group based at least in part on a slot type associated with a slot in which a monitoring occasion associated with the search space occurs.

For example, the search space may be associated with a first monitoring occasion that occurs in a first slot (e.g., a downlink slot or a half-duplex slot), as shown in FIG. 12. The UE 120 and/or the network node may use a first CORESET (e.g., from a first CORESET group) during the first monitoring occasion. For example, the search space configuration may indicate that the first CORESET and/or the first CORESET group is associated with half-duplex slots and/or downlink slots.

The search space may be associated with a second monitoring occasion that occurs in a third slot (e.g., a full-duplex slot or an SBFD slot), as shown in FIG. 12. The UE 120 and/or the network node may use a second CORESET (e.g., from a second CORESET group) during the second monitoring occasion. For example, the search space configuration may indicate that the second CORESET and/or the second CORESET group is associated with full-duplex slots and/or SBFD slots. The UE 120 and/or the network node 110 may switch an active CORESET and/or an active CORESET group for the search space from the first CORESET and/or the first CORESET group to the second CORESET and/or the second CORESET group because the second monitoring occasion occurs during a full-duplex slot and/or an SBFD slot (e.g., the third slot). For example, the network node 110 may configure CORESET(s) for the search space that are associated with full-duplex slots and/or SBFD slots such that frequency domain resources of the CORESET(s) do not overlap, in the frequency domain, with uplink resources and/or guard band resources of the full-duplex slots and/or SBFD slots.

This conserves processing resources, memory resources, and/or power resources, among other examples, associated with identifying frequency domain resources of a CORESET that at least partially overlap with uplink resources or guard band resources of a full-duplex slot, while still ensuring that frequency domain resources (e.g., CCEs and/or RBs) of a CORESET that overlap, in the frequency domain, with uplink resources or guard band resources of a full-duplex slot are not used by the UE 120 and/or the network node 110 for control channel communications (e.g., for PDCCH monitoring).

As indicated above, FIG. 12 is provided as an example. Other examples may differ from what is described with respect to FIG. 12.

FIG. 13 is a diagram illustrating an example process 1300 performed, for example, by a UE, in accordance with the present disclosure. Example process 1300 is an example where the UE (e.g., UE 120) performs operations associated with enhanced CORESET configurations for full-duplex operations.

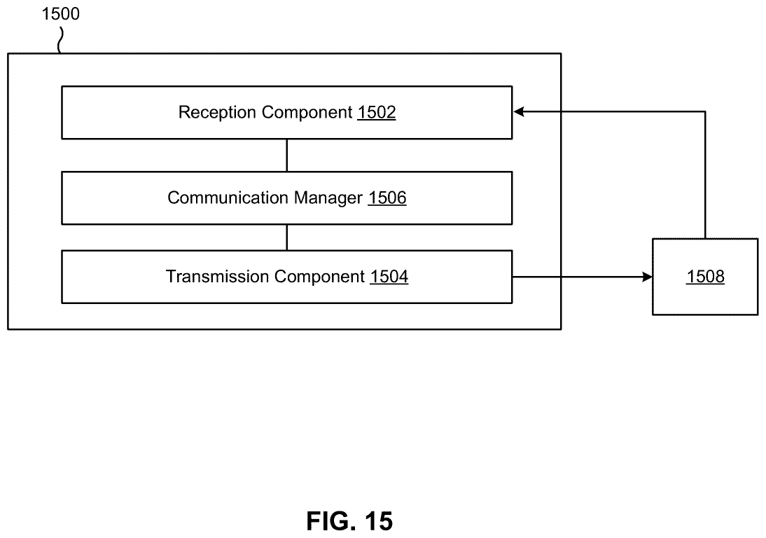

As shown in FIG. 13, in some aspects, process 1300 may include receiving, from a network node, CORESET configuration information that is associated with one or more CORESETs (block 1310). For example, the UE (e.g., using reception component 1502 and/or communication manager 1506, depicted in FIG. 15) may receive, from a network node, CORESET configuration information that is associated with one or more CORESETs, as described above.

As further shown in FIG. 13, in some aspects, process 1300 may include receiving, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type (block 1320). For example, the UE (e.g., using reception component 1502 and/or communication manager 1506, depicted in FIG. 15) may receive, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type, as described above.

Process 1300 may include additional aspects, such as any single aspect or any combination of aspects described below and/or in connection with one or more other processes described elsewhere herein.

In a first aspect, the CORESET configuration information indicates a set of frequency domain resources associated with the CORESET, and the configuration that is based at least on part on the slot type includes the set of frequency domain resources if the slot type is the half-duplex slot type, or a subset of frequency domain resources, of the set of frequency domain resources, if the slot type is the full-duplex slot type.

In a second aspect, alone or in combination with the first aspect, the full-duplex slot type includes first one or more subbands associated with downlink communications, second one or more subbands associated with uplink communications, and one or more guard bands, and the subset of frequency domain resources includes frequency domain resources that do not overlap in a frequency domain with the second one or more subbands or the one or more guard bands.

In a third aspect, alone or in combination with one or more of the first and second aspects, the CORESET configuration information indicates a set of frequency domain resources associated with the CORESET, where the slot type is the full-duplex slot type, and the configuration that is based at least on part on the slot type is an adapted configuration associated with first frequency domain resources, of the set of frequency domain resources, that do not overlap in a frequency domain with uplink resources or guard band resources of the slot being available for the CORESET, and second frequency domain resources, of the set of frequency domain resources, that at least partially overlap in the frequency domain with the uplink resources or the guard band resources of the slot being unavailable for the CORESET.

In a fourth aspect, alone or in combination with one or more of the first through third aspects, the CORESET configuration information indicates a set of frequency domain resources associated with the CORESET, and process 1300 includes performing one or more operations associated with the CORESET using only a subset of frequency domain resources of the set of frequency domain resources if the slot type is the full-duplex slot type, or the set of frequency domain resources if the slot type is the half-duplex slot type, and the subset of frequency domain resources includes frequency domain resources that do not overlap in a frequency domain with uplink resources or guard band resources of the slot.

In a fifth aspect, alone or in combination with one or more of the first through fourth aspects, performing the one or more operations includes mapping one or more PDCCH candidates to the subset of frequency domain resources if the slot type is the full-duplex slot type, or the set of frequency domain resources if the slot type is the half-duplex slot type.

In a sixth aspect, alone or in combination with one or more of the first through fifth aspects, performing the one or more operations includes performing an interleaving operation using only the subset of frequency domain resources if the slot type is the full-duplex slot type, or the set of frequency domain resources if the slot type is the half-duplex slot type.

In a seventh aspect, alone or in combination with one or more of the first through sixth aspects, the CORESET configuration information is associated with a search space configuration associated with a search space that is associated with a first CORESET and a second CORESET of the one or more CORESETs, where the slot is associated with a control channel monitoring occasion that is associated with the search space, and the CORESET is the first CORESET if the slot type is the full-duplex slot type or the second CORESET if the slot type is the half-duplex slot type.

In an eighth aspect, alone or in combination with one or more of the first through seventh aspects, the first CORESET is associated with a first set of frequency domain resources and the second CORESET is associated with a second set of frequency domain resources, and the first set of frequency domain resources do not overlap, in a frequency domain, with uplink resources or guard band resources of the full-duplex slot type.

In a ninth aspect, alone or in combination with one or more of the first through eighth aspects, the CORESET configuration information is associated with a search space configuration associated with a search space, where the search space configuration indicates that the search space is associated with a first CORESET group and a second CORESET group, where the CORESET configuration information indicates groups, from the first CORESET group or the second CORESET group, associated with respective CORESETs of the one or more CORESETs, where the first CORESET group is associated with the full-duplex slot type and the second CORESET group is associated with the half-duplex slot type, and the CORESET is selected from the first CORESET group or the second CORESET group based at least in part on the slot type.

In a tenth aspect, alone or in combination with one or more of the first through ninth aspects, the CORESET configuration information is associated with a search space configuration associated with a search space, where the search space configuration indicates that the search space is associated with a first CORESET group and a second CORESET group, and where the slot is associated with a control channel monitoring occasion that is associated with the search space, and process 1300 includes activating an active CORESET group, of the first CORESET group or the second CORESET group, based at least in part on the slot type, where the CORESET is included in the active CORESET group.

In an eleventh aspect, alone or in combination with one or more of the first through tenth aspects, the first CORESET group is associated with the full-duplex slot type and the second CORESET group is associated with the half-duplex slot type, where the slot type is the half-duplex slot type, and the active CORESET group is the second CORESET group, and process 1300 includes switching, for another control channel monitoring occasion, included in another slot, that is associated with the search space, the active CORESET group from the second CORESET group to the first CORESET group based at least in part on the other slot being the full-duplex slot type, and receiving, during the other slot, another control channel communication using another CORESET, of the one or more CORESETs, that is included in the first CORESET group, based at least in part on switching the active CORESET group.

In a twelfth aspect, alone or in combination with one or more of the first through eleventh aspects, the CORESET configuration information is associated with a search space configuration associated with a search space that is associated with the CORESET configuration information, and the search space is a UE-specific search space.

In a thirteenth aspect, alone or in combination with one or more of the first through twelfth aspects, process 1300 includes transmitting, to the network node, a capability report indicating that the UE supports adapting CORESET configurations according to slot types, and the reception of the control channel communication using the configuration that is based at least on part on the slot type is based at least in part on the transmission of the capability report.

In a fourteenth aspect, alone or in combination with one or more of the first through thirteenth aspects, the CORESET is associated with a set of frequency domain resources, and the set of frequency domain resources includes one or more control channel elements.

In a fifteenth aspect, alone or in combination with one or more of the first through fourteenth aspects, the full-duplex slot type includes a subband full-duplex slot type.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., network node 110) performs operations associated with techniques for enhanced CORESET configurations for full-duplex operations.

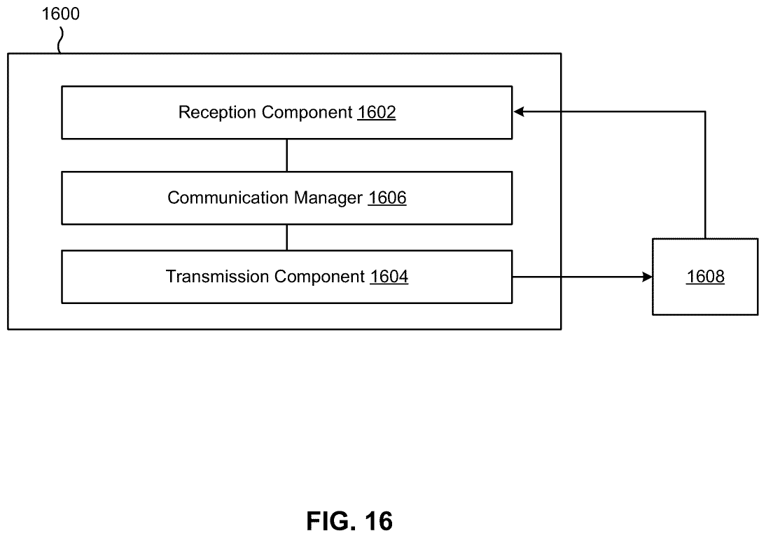

As shown in FIG. 14, in some aspects, process 1400 may include transmitting CORESET configuration information, associated with a UE, that is associated with one or more CORESETs (block 1410). For example, the network node (e.g., using transmission component 1604 and/or communication manager 1606, depicted in FIG. 16) may transmit CORESET configuration information, associated with a UE, that is associated with one or more CORESETs, as described above.

As further shown in FIG. 14, in some aspects, process 1400 may include transmitting, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type (block 1420). For example, the network node (e.g., using transmission component 1604 and/or communication manager 1606, depicted in FIG. 16) may transmit, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type, as described above.

Process 1400 may include additional aspects, such as any single aspect or any combination of aspects described below and/or in connection with one or more other processes described elsewhere herein.

In a first aspect, the CORESET configuration information indicates a set of frequency domain resources associated with the CORESET, and the configuration that is based at least on part on the slot type includes the set of frequency domain resources if the slot type is the half-duplex slot type, or a subset of frequency domain resources, of the set of frequency domain resources, if the slot type is the full-duplex slot type.

In a second aspect, alone or in combination with the first aspect, the full-duplex slot type includes first one or more subbands associated with downlink communications, second one or more subbands associated with uplink communications, and one or more guard bands, and the subset of frequency domain resources includes frequency domain resources that do not overlap in a frequency domain with the second one or more subbands or the one or more guard bands.

In a third aspect, alone or in combination with one or more of the first and second aspects, the CORESET configuration information indicates a set of frequency domain resources associated with the CORESET, where the slot type is the full-duplex slot type, and the configuration that is based at least on part on the slot type is an adapted configuration associated with first frequency domain resources, of the set of frequency domain resources, that do not overlap in a frequency domain with uplink resources or guard band resources of the slot being available for the CORESET, and second frequency domain resources, of the set of frequency domain resources, that at least partially overlap in the frequency domain with the uplink resources or the guard band resources of the slot being unavailable for the CORESET.

In a fourth aspect, alone or in combination with one or more of the first through third aspects, the CORESET configuration information indicates a set of frequency domain resources associated with the CORESET, and process 1400 includes performing one or more operations associated with the CORESET using only a subset of frequency domain resources of the set of frequency domain resources if the slot type is the full-duplex slot type, or the set of frequency domain resources if the slot type is the half-duplex slot type, and the subset of frequency domain resources includes frequency domain resources that do not overlap in a frequency domain with uplink resources or guard band resources of the slot.

In a fifth aspect, alone or in combination with one or more of the first through fourth aspects, performing the one or more operations includes mapping one or more PDCCH candidates to the subset of frequency domain resources if the slot type is the full-duplex slot type, or the set of frequency domain resources if the slot type is the half-duplex slot type.

In a sixth aspect, alone or in combination with one or more of the first through fifth aspects, performing the one or more operations includes performing an interleaving operation using only the subset of frequency domain resources if the slot type is the full-duplex slot type, or the set of frequency domain resources if the slot type is the half-duplex slot type.

In a seventh aspect, alone or in combination with one or more of the first through sixth aspects, the CORESET configuration information is associated with a search space configuration associated with a search space that is associated with a first CORESET and a second CORESET of the one or more CORESETs, where the slot is associated with a control channel monitoring occasion that is associated with the search space, and the CORESET is the first CORESET if the slot type is the full-duplex slot type or the second CORESET if the slot type is the half-duplex slot type.

In an eighth aspect, alone or in combination with one or more of the first through seventh aspects, the first CORESET is associated with a first set of frequency domain resources and the second CORESET is associated with a second set of frequency domain resources, and the first set of frequency domain resources do not overlap, in a frequency domain, with uplink resources or guard band resources of the full-duplex slot type.

In a ninth aspect, alone or in combination with one or more of the first through eighth aspects, the CORESET configuration information is associated with a search space configuration associated with a search space, where the search space configuration indicates that the search space is associated with a first CORESET group and a second CORESET group, where the CORESET configuration information indicates groups, from the first CORESET group or the second CORESET group, associated with respective CORESETs of the one or more CORESETs, where the first CORESET group is associated with the full-duplex slot type and the second CORESET group is associated with the half-duplex slot type, and the CORESET is selected from the first CORESET group or the second CORESET group based at least in part on the slot type.

In a tenth aspect, alone or in combination with one or more of the first through ninth aspects, the CORESET configuration information is associated with a search space configuration associated with a search space, where the search space configuration indicates that the search space is associated with a first CORESET group and a second CORESET group, and the slot is associated with a control channel monitoring occasion that is associated with the search space, and process 1400 includes activating an active CORESET group, of the first CORESET group or the second CORESET group, based at least in part on the slot type, where the CORESET is included in the active CORESET group.

In an eleventh aspect, alone or in combination with one or more of the first through tenth aspects, the first CORESET group is associated with the full-duplex slot type and the second CORESET group is associated with the half-duplex slot type, where the slot type is the half-duplex slot type, and the active CORESET group is the second CORESET group, and process 1400 includes switching, for another control channel monitoring occasion, included in another slot, that is associated with the search space, the active CORESET group from the second CORESET group to the first CORESET group based at least in part on the other slot being the full-duplex slot type, and receiving, during the other slot, another control channel communication using another CORESET, of the one or more CORESETs, that is included in the first CORESET group based at least in part on switching the active CORESET group.

In a twelfth aspect, alone or in combination with one or more of the first through eleventh aspects, the CORESET configuration information is associated with a search space configuration associated with a search space that is associated with the CORESET configuration information, and the search space is a UE-specific search space.

In a thirteenth aspect, alone or in combination with one or more of the first through twelfth aspects, process 1400 includes receiving a capability report indicating that the UE supports adapting CORESET configurations according to slot types, and the transmission of the control channel communication using the configuration that is based at least on part on the slot type is based at least in part on the reception of the capability report.

In a fourteenth aspect, alone or in combination with one or more of the first through thirteenth aspects, the CORESET is associated with a set of frequency domain resources, and the set of frequency domain resources includes one or more control channel elements.

In a fifteenth aspect, alone or in combination with one or more of the first through fourteenth aspects, the full-duplex slot type includes a subband full-duplex slot type.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 10-12. Additionally, or alternatively, the apparatus 1500 may be configured to perform one or more processes described herein, such as process 1300 of FIG. 13, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The reception component 1502 may receive, from a network node, CORESET configuration information that is associated with one or more CORESETs. The reception component 1502 may receive, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type.

The transmission component 1504 may transmit, to the network node, a capability report indicating that the UE supports adapting CORESET configurations according to slot types, wherein the reception of the control channel communication using the configuration that is based at least on part on the slot type is based at least in part on the transmission of the capability report.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 150 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 10-12. Additionally, or alternatively, the apparatus 1600 may be configured to perform one or more processes described herein, such as process 1400 of FIG. 14, or a combination thereof. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The transmission component 1604 may transmit CORESET configuration information, associated with a UE, that is associated with one or more CORESETs. The transmission component 1604 may transmit, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type.

The reception component 1602 may receive a capability report indicating that the UE supports adapting CORESET configurations according to slot types, wherein the transmission of the control channel communication using the configuration that is based at least on part on the slot type is based at least in part on the reception of the capability report.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: receiving, from a network node, control resource set (CORESET) configuration information that is associated with one or more CORESETs; and receiving, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type.

Aspect 2: The method of Aspect 1, wherein the CORESET configuration information indicates a set of frequency domain resources associated with the CORESET, and wherein the configuration that is based at least on part on the slot type includes: the set of frequency domain resources if the slot type is the half-duplex slot type, or a subset of frequency domain resources, of the set of frequency domain resources, if the slot type is the full-duplex slot type.

Aspect 3: The method of Aspect 2, wherein the full-duplex slot type includes first one or more subbands associated with downlink communications, second one or more subbands associated with uplink communications, and one or more guard bands, and wherein the subset of frequency domain resources includes frequency domain resources that do not overlap in a frequency domain with the second one or more subbands or the one or more guard bands.

Aspect 4: The method of any of Aspects 1-3, wherein the CORESET configuration information indicates a set of frequency domain resources associated with the CORESET, wherein the slot type is the full-duplex slot type, and wherein the configuration that is based at least on part on the slot type is an adapted configuration associated with: first frequency domain resources, of the set of frequency domain resources, that do not overlap in a frequency domain with uplink resources or guard band resources of the slot being available for the CORESET, and second frequency domain resources, of the set of frequency domain resources, that at least partially overlap in the frequency domain with the uplink resources or the guard band resources of the slot being unavailable for the CORESET.

Aspect 5: The method of any of Aspects 1-4, wherein the CORESET configuration information indicates a set of frequency domain resources associated with the CORESET, the method further comprising: performing one or more operations associated with the CORESET using: only a subset of frequency domain resources of the set of frequency domain resources if the slot type is the full-duplex slot type, or the set of frequency domain resources if the slot type is the half-duplex slot type, and wherein the subset of frequency domain resources includes frequency domain resources that do not overlap in a frequency domain with uplink resources or guard band resources of the slot.

Aspect 6: The method of Aspect 5, wherein performing the one or more operations comprises: mapping one or more physical downlink control channel (PDCCH) candidates to: the subset of frequency domain resources if the slot type is the full-duplex slot type, or the set of frequency domain resources if the slot type is the half-duplex slot type.

Aspect 7: The method of any of Aspects 5-6, wherein performing the one or more operations comprises: performing an interleaving operation using: only the subset of frequency domain resources if the slot type is the full-duplex slot type, or the set of frequency domain resources if the slot type is the half-duplex slot type.

Aspect 8: The method of any of Aspects 1-7, wherein the CORESET configuration information is associated with a search space configuration associated with a search space that is associated with a first CORESET and a second CORESET of the one or more CORESETs, wherein the slot is associated with a control channel monitoring occasion that is associated with the search space, and wherein the CORESET is the first CORESET if the slot type is the full-duplex slot type or the second CORESET if the slot type is the half-duplex slot type.

Aspect 9: The method of Aspect 8, wherein the first CORESET is associated with a first set of frequency domain resources and the second CORESET is associated with a second set of frequency domain resources, and wherein the first set of frequency domain resources do not overlap, in a frequency domain, with uplink resources or guard band resources of the full-duplex slot type.

Aspect 10: The method of any of Aspects 1-9, wherein the CORESET configuration information is associated with a search space configuration associated with a search space, wherein the search space configuration indicates that the search space is associated with a first CORESET group and a second CORESET group, wherein the CORESET configuration information indicates groups, from the first CORESET group or the second CORESET group, associated with respective CORESETs of the one or more CORESETs, wherein the first CORESET group is associated with the full-duplex slot type and the second CORESET group is associated with the half-duplex slot type, and wherein the CORESET is selected from the first CORESET group or the second CORESET group based at least in part on the slot type.

Aspect 11: The method of any of Aspects 1-10, wherein the CORESET configuration information is associated with a search space configuration associated with a search space, wherein the search space configuration indicates that the search space is associated with a first CORESET group and a second CORESET group, and wherein the slot is associated with a control channel monitoring occasion that is associated with the search space, the method further comprising: activating an active CORESET group, of the first CORESET group or the second CORESET group, based at least in part on the slot type, wherein the CORESET is included in the active CORESET group.

Aspect 12: The method of Aspect 11, wherein the first CORESET group is associated with the full-duplex slot type and the second CORESET group is associated with the half-duplex slot type, wherein the slot type is the half-duplex slot type, and wherein the active CORESET group is the second CORESET group, the method further comprising: switching, for another control channel monitoring occasion, included in another slot, that is associated with the search space, the active CORESET group from the second CORESET group to the first CORESET group based at least in part on the other slot being the full-duplex slot type; and receiving, during the other slot, another control channel communication using another CORESET, of the one or more CORESETs, that is included in the first CORESET group, based at least in part on switching the active CORESET group.

Aspect 13: The method of any of Aspects 1-12, wherein the CORESET configuration information is associated with a search space configuration associated with a search space that is associated with the CORESET configuration information, and wherein the search space is a UE-specific search space.

Aspect 14: The method of any of Aspects 1-13, further comprising: transmitting, to the network node, a capability report indicating that the UE supports adapting CORESET configurations according to slot types, and wherein the reception of the control channel communication using the configuration that is based at least on part on the slot type is based at least in part on the transmission of the capability report.

Aspect 15: The method of any of Aspects 1-14, wherein the CORESET is associated with a set of frequency domain resources, and wherein the set of frequency domain resources includes one or more control channel elements.

Aspect 16: The method of any of Aspects 1-15, wherein the full-duplex slot type includes a subband full-duplex slot type.

Aspect 17: A method of wireless communication performed by a network node, comprising: transmitting control resource set (CORESET) configuration information, associated with a user equipment (UE), that is associated with one or more CORESETs; and transmitting, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type.

Aspect 18: The method of Aspect 17, wherein the CORESET configuration information indicates a set of frequency domain resources associated with the CORESET, and wherein the configuration that is based at least on part on the slot type includes: the set of frequency domain resources if the slot type is the half-duplex slot type, or a subset of frequency domain resources, of the set of frequency domain resources, if the slot type is the full-duplex slot type.

Aspect 19: The method of Aspect 18, wherein the full-duplex slot type includes first one or more subbands associated with downlink communications, second one or more subbands associated with uplink communications, and one or more guard bands, and wherein the subset of frequency domain resources includes frequency domain resources that do not overlap in a frequency domain with the second one or more subbands or the one or more guard bands.

Aspect 20: The method of any of Aspects 17-19, wherein the CORESET configuration information indicates a set of frequency domain resources associated with the CORESET, wherein the slot type is the full-duplex slot type, and wherein the configuration that is based at least on part on the slot type is an adapted configuration associated with: first frequency domain resources, of the set of frequency domain resources, that do not overlap in a frequency domain with uplink resources or guard band resources of the slot being available for the CORESET, and second frequency domain resources, of the set of frequency domain resources, that at least partially overlap in the frequency domain with the uplink resources or the guard band resources of the slot being unavailable for the CORESET.

Aspect 21: The method of any of Aspects 17-20, wherein the CORESET configuration information indicates a set of frequency domain resources associated with the CORESET, the method further comprising: performing one or more operations associated with the CORESET using: only a subset of frequency domain resources of the set of frequency domain resources if the slot type is the full-duplex slot type, or the set of frequency domain resources if the slot type is the half-duplex slot type, and wherein the subset of frequency domain resources includes frequency domain resources that do not overlap in a frequency domain with uplink resources or guard band resources of the slot.

Aspect 22: The method of Aspect 21, wherein performing the one or more operations comprises: mapping one or more physical downlink control channel (PDCCH) candidates to: the subset of frequency domain resources if the slot type is the full-duplex slot type, or the set of frequency domain resources if the slot type is the half-duplex slot type.

Aspect 23: The method of any of Aspects 21-22, wherein performing the one or more operations comprises: performing an interleaving operation using: only the subset of frequency domain resources if the slot type is the full-duplex slot type, or the set of frequency domain resources if the slot type is the half-duplex slot type.

Aspect 24: The method of any of Aspects 17-23, wherein the CORESET configuration information is associated with a search space configuration associated with a search space that is associated with a first CORESET and a second CORESET of the one or more CORESETs, wherein the slot is associated with a control channel monitoring occasion that is associated with the search space, and wherein the CORESET is the first CORESET if the slot type is the full-duplex slot type or the second CORESET if the slot type is the half-duplex slot type.

Aspect 25: The method of Aspect 24, wherein the first CORESET is associated with a first set of frequency domain resources and the second CORESET is associated with a second set of frequency domain resources, and wherein the first set of frequency domain resources do not overlap, in a frequency domain, with uplink resources or guard band resources of the full-duplex slot type.

Aspect 26: The method of any of Aspects 17-25, wherein the CORESET configuration information is associated with a search space configuration associated with a search space, wherein the search space configuration indicates that the search space is associated with a first CORESET group and a second CORESET group, wherein the CORESET configuration information indicates groups, from the first CORESET group or the second CORESET group, associated with respective CORESETs of the one or more CORESETs, wherein the first CORESET group is associated with the full-duplex slot type and the second CORESET group is associated with the half-duplex slot type, and wherein the CORESET is selected from the first CORESET group or the second CORESET group based at least in part on the slot type.

Aspect 27: The method of any of Aspects 17-26, wherein the CORESET configuration information is associated with a search space configuration associated with a search space, wherein the search space configuration indicates that the search space is associated with a first CORESET group and a second CORESET group, and wherein the slot is associated with a control channel monitoring occasion that is associated with the search space, the method further comprising: activating an active CORESET group, of the first CORESET group or the second CORESET group, based at least in part on the slot type, wherein the CORESET is included in the active CORESET group.

Aspect 28: The method of Aspect 27, wherein the first CORESET group is associated with the full-duplex slot type and the second CORESET group is associated with the half-duplex slot type, wherein the slot type is the half-duplex slot type, and wherein the active CORESET group is the second CORESET group, the method further comprising: switching, for another control channel monitoring occasion, included in another slot, that is associated with the search space, the active CORESET group from the second CORESET group to the first CORESET group based at least in part on the other slot being the full-duplex slot type; and receiving, during the other slot, another control channel communication using another CORESET, of the one or more CORESETs, that is included in the first CORESET group based at least in part on switching the active CORESET group.

Aspect 29: The method of any of Aspects 17-28, wherein the CORESET configuration information is associated with a search space configuration associated with a search space that is associated with the CORESET configuration information, and wherein the search space is a UE-specific search space.

Aspect 30: The method of any of Aspects 17-29, further comprising: receiving a capability report indicating that the UE supports adapting CORESET configurations according to slot types, and wherein the transmission of the control channel communication using the configuration that is based at least on part on the slot type is based at least in part on the reception of the capability report.

Aspect 31: The method of any of Aspects 17-30, wherein the CORESET is associated with a set of frequency domain resources, and wherein the set of frequency domain resources includes one or more control channel elements.

Aspect 32: The method of any of Aspects 17-31, wherein the full-duplex slot type includes a subband full-duplex slot type.

Aspect 33: An apparatus for wireless communication at a device, comprising a processor; memory coupled with the processor; and instructions stored in the memory and executable by the processor to cause the apparatus to perform the method of one or more of Aspects 1-16.

Aspect 34: A device for wireless communication, comprising a memory and one or more processors coupled to the memory, the one or more processors configured to perform the method of one or more of Aspects 1-16.

Aspect 35: An apparatus for wireless communication, comprising at least one means for performing the method of one or more of Aspects 1-16.

Aspect 36: A non-transitory computer-readable medium storing code for wireless communication, the code comprising instructions executable by a processor to perform the method of one or more of Aspects 1-16.

Aspect 37: A non-transitory computer-readable medium storing a set of instructions for wireless communication, the set of instructions comprising one or more instructions that, when executed by one or more processors of a device, cause the device to perform the method of one or more of Aspects 1-16.

Aspect 38: An apparatus for wireless communication at a device, comprising a processor; memory coupled with the processor; and instructions stored in the memory and executable by the processor to cause the apparatus to perform the method of one or more of Aspects 17-32.

Aspect 39: A device for wireless communication, comprising a memory and one or more processors coupled to the memory, the one or more processors configured to perform the method of one or more of Aspects 17-32.

Aspect 40: An apparatus for wireless communication, comprising at least one means for performing the method of one or more of Aspects 17-32.

Aspect 41: A non-transitory computer-readable medium storing code for wireless communication, the code comprising instructions executable by a processor to perform the method of one or more of Aspects 17-32.

Aspect 42: A non-transitory computer-readable medium storing a set of instructions for wireless communication, the set of instructions comprising one or more instructions that, when executed by one or more processors of a device, cause the device to perform the method of one or more of Aspects 17-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving, from a network node, control resource set (CORESET) configuration information that is associated with one or more CORESETs; and
receiving, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type.

2. The method of claim 1, wherein the CORESET configuration information indicates a set of frequency domain resources associated with the CORESET, and wherein the configuration that is based at least on part on the slot type includes:
the set of frequency domain resources if the slot type is the half-duplex slot type, or
a subset of frequency domain resources, of the set of frequency domain resources, if the slot type is the full-duplex slot type.

3. The method of claim 2, wherein the full-duplex slot type includes first one or more subbands associated with downlink communications, second one or more subbands associated with uplink communications, and one or more guard bands, and
wherein the subset of frequency domain resources includes frequency domain resources that do not overlap in a frequency domain with the second one or more subbands or the one or more guard bands.

4. The method of claim 1, wherein the CORESET configuration information indicates a set of frequency domain resources associated with the CORESET,
wherein the slot type is the full-duplex slot type, and
wherein the configuration that is based at least on part on the slot type is an adapted configuration associated with:
first frequency domain resources, of the set of frequency domain resources, that do not overlap in a frequency domain with uplink resources or guard band resources of the slot being available for the CORESET, and
second frequency domain resources, of the set of frequency domain resources, that at least partially overlap in the frequency domain with the uplink resources or the guard band resources of the slot being unavailable for the CORESET.

5. The method of claim 1, wherein the CORESET configuration information indicates a set of frequency domain resources associated with the CORESET, the method further comprising:
performing one or more operations associated with the CORESET using only a subset of frequency domain resources of the set of frequency domain resources if the slot type is the full-duplex slot type,
wherein the subset of frequency domain resources includes frequency domain resources that do not overlap in a frequency domain with uplink resources or guard band resources of the slot.

6. The method of claim 5, wherein performing the one or more operations comprises:
mapping one or more physical downlink control channel (PDCCH) candidates to the subset of frequency domain resources if the slot type is the full-duplex slot type.

7. The method of claim 5, wherein performing the one or more operations comprises:
performing an interleaving operation using only the subset of frequency domain resources if the slot type is the full-duplex slot type.

8. The method of claim 1, wherein the CORESET configuration information is associated with a search space configuration associated with a search space that is associated with a first CORESET and a second CORESET of the one or more CORESETs,
wherein the slot is associated with a control channel monitoring occasion that is associated with the search space, and
wherein the CORESET is the first CORESET if the slot type is the full-duplex slot type or the second CORESET if the slot type is the half-duplex slot type.

9. The method of claim 8, wherein the first CORESET is associated with a first set of frequency domain resources and the second CORESET is associated with a second set of frequency domain resources, and
wherein the first set of frequency domain resources do not overlap, in a frequency domain, with uplink resources or guard band resources of the full-duplex slot type.

10. The method of claim 1, wherein the CORESET configuration information is associated with a search space configuration associated with a search space,
wherein the search space configuration indicates that the search space is associated with a first CORESET group and a second CORESET group,
wherein the CORESET configuration information indicates groups, from the first CORESET group or the second CORESET group, associated with respective CORESETs of the one or more CORESETs,
wherein the first CORESET group is associated with the full-duplex slot type and the second CORESET group is associated with the half-duplex slot type, and
wherein the CORESET is selected from the first CORESET group or the second CORESET group based at least in part on the slot type.

11. The method of claim 1, wherein the CORESET configuration information is associated with a search space configuration associated with a search space,
wherein the search space configuration indicates that the search space is associated with a first CORESET group and a second CORESET group, and
wherein the slot is associated with a control channel monitoring occasion that is associated with the search space, the method further comprising:
activating an active CORESET group, of the first CORESET group or the second CORESET group, based at least in part on the slot type, wherein the CORESET is included in the active CORESET group.

12. The method of claim 11, wherein the first CORESET group is associated with the full-duplex slot type and the second CORESET group is associated with the half-duplex slot type, wherein the slot type is the half-duplex slot type, and wherein the active CORESET group is the second CORESET group, the method further comprising:
switching, for another control channel monitoring occasion, included in another slot, that is associated with the search space, the active CORESET group from the second CORESET group to the first CORESET group based at least in part on the other slot being the full-duplex slot type; and
receiving, during the other slot, another control channel communication using another CORESET, of the one or more CORESETs, that is included in the first CORESET group, based at least in part on switching the active CORESET group.

13. The method of claim 1, wherein the CORESET configuration information is associated with a search space configuration associated with a search space that is associated with the CORESET configuration information, and
wherein the search space is a UE-specific search space.

14. The method of claim 1, further comprising:
transmitting, to the network node, a capability report indicating that the UE supports adapting CORESET configurations according to slot types, and wherein the reception of the control channel communication using the configuration that is based at least on part on the slot type is based at least in part on the transmission of the capability report.

15. The method of claim 1, wherein the CORESET is associated with a set of frequency domain resources, and wherein the set of frequency domain resources includes one or more control channel elements.

16. The method of claim 1, wherein the full-duplex slot type includes a subband full-duplex slot type.

17. A method of wireless communication performed by a network node, comprising:
transmitting control resource set (CORESET) configuration information, associated with a user equipment (UE), that is associated with one or more CORESETs; and
transmitting, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type.

18. The method of claim 17, wherein the CORESET configuration information indicates a set of frequency domain resources associated with the CORESET, and wherein the configuration that is based at least on part on the slot type includes:
the set of frequency domain resources if the slot type is the half-duplex slot type, or
a subset of frequency domain resources, of the set of frequency domain resources, if the slot type is the full-duplex slot type.

19. The method of claim 18, wherein the full-duplex slot type includes first one or more subbands associated with downlink communications, second one or more subbands associated with uplink communications, and one or more guard bands, and
wherein the subset of frequency domain resources includes frequency domain resources that do not overlap in a frequency domain with the second one or more subbands or the one or more guard bands.

20. The method of claim 17, wherein the CORESET configuration information indicates a set of frequency domain resources associated with the CORESET,
wherein the slot type is the full-duplex slot type, and
wherein the configuration that is based at least on part on the slot type is an adapted configuration associated with:
first frequency domain resources, of the set of frequency domain resources, that do not overlap in a frequency domain with uplink resources or guard band resources of the slot being available for the CORESET, and
second frequency domain resources, of the set of frequency domain resources, that at least partially overlap in the frequency domain with the uplink resources or the guard band resources of the slot being unavailable for the CORESET.

21. The method of claim 17, wherein the CORESET configuration information is associated with a search space configuration associated with a search space that is associated with a first CORESET and a second CORESET of the one or more CORESETs,
wherein the slot is associated with a control channel monitoring occasion that is associated with the search space, and
wherein the CORESET is the first CORESET if the slot type is the full-duplex slot type or the second CORESET if the slot type is the half-duplex slot type.

22. The method of claim 17, wherein the CORESET configuration information is associated with a search space configuration associated with a search space,
wherein the search space configuration indicates that the search space is associated with a first CORESET group and a second CORESET group,
wherein the CORESET configuration information indicates groups, from the first CORESET group or the second CORESET group, associated with respective CORESETs of the one or more CORESETs,
wherein the first CORESET group is associated with the full-duplex slot type and the second CORESET group is associated with the half-duplex slot type, and
wherein the CORESET is selected from the first CORESET group or the second CORESET group based at least in part on the slot type.

23. The method of claim 17, wherein the CORESET configuration information is associated with a search space configuration associated with a search space,
wherein the search space configuration indicates that the search space is associated with a first CORESET group and a second CORESET group, and
wherein the slot is associated with a control channel monitoring occasion that is associated with the search space, the method further comprising:
activating an active CORESET group, of the first CORESET group or the second CORESET group, based at least in part on the slot type, wherein the CORESET is included in the active CORESET group.

24. A user equipment (UE) for wireless communication, comprising:
a memory; and
one or more processors, coupled to the memory, configured to:
receive, from a network node, control resource set (CORESET) configuration information that is associated with one or more CORESETs; and
receive, from the network node and during a slot, a control channel communication via a CORESET of the one or more CORESETs, the CORESET being associated with a configuration that is based at least on part on a slot type associated with the slot, the slot type including at least one of a full-duplex slot type or a half-duplex slot type.

25. The UE of claim 24, wherein the CORESET configuration information indicates a set of frequency domain resources associated with the CORESET, and wherein the configuration that is based at least on part on the slot type includes:
the set of frequency domain resources if the slot type is the half-duplex slot type, or
a subset of frequency domain resources, of the set of frequency domain resources, if the slot type is the full-duplex slot type.

26. The UE of claim 25, wherein the full-duplex slot type includes first one or more subbands associated with downlink communications, second one or more subbands associated with uplink communications, and one or more guard bands, and wherein the subset of frequency domain resources includes frequency domain resources that do not overlap in a frequency domain with the second one or more subbands or the one or more guard bands.

27. The UE of claim 24, wherein the CORESET configuration information indicates a set of frequency domain resources associated with the CORESET,
wherein the slot type is the full-duplex slot type, and
wherein the configuration that is based at least on part on the slot type is an adapted configuration associated with:
first frequency domain resources, of the set of frequency domain resources, that do not overlap in a frequency domain with uplink resources or guard band resources of the slot being available for the CORESET, and
second frequency domain resources, of the set of frequency domain resources, that at least partially overlap in the frequency domain with the uplink resources or the guard band resources of the slot being unavailable for the CORESET.

28. The UE of claim 24, wherein the CORESET configuration information indicates a set of frequency domain resources associated with the CORESET, wherein the one or more processors are further configured to:
perform one or more operations associated with the CORESET using:
only a subset of frequency domain resources of the set of frequency domain resources if the slot type is the full-duplex slot type, or
the set of frequency domain resources if the slot type is the half-duplex slot type, and
wherein the subset of frequency domain resources includes frequency domain resources that do not overlap in a frequency domain with uplink resources or guard band resources of the slot.

29. The UE of claim 24, wherein the CORESET configuration information is associated with a search space configuration associated with a search space that is associated with a first CORESET and a second CORESET of the one or more CORESETs,
wherein the slot is associated with a control channel monitoring occasion that is associated with the search space, and
wherein the CORESET is the first CORESET if the slot type is the full-duplex slot type or the second CORESET if the slot type is the half-duplex slot type.

30. The UE of claim 29, wherein the first CORESET is associated with a first set of frequency domain resources and the second CORESET is associated with a second set of frequency domain resources, and
wherein the first set of frequency domain resources do not overlap, in a frequency domain, with uplink resources or guard band resources of the full-duplex slot type.

31. The UE of claim 24, wherein the CORESET configuration information is associated with a search space configuration associated with a search space,
wherein the search space configuration indicates that the search space is associated with a first CORESET group and a second CORESET group,
wherein the CORESET configuration information indicates groups, from the first CORESET group or the second CORESET group, associated with respective CORESETs of the one or more CORESETs,
wherein the first CORESET group is associated with the full-duplex slot type and the second CORESET group is associated with the half-duplex slot type, and
wherein the CORESET is selected from the first CORESET group or the second CORESET group based at least in part on the slot type.

32. The UE of claim 24, wherein the CORESET configuration information is associated with a search space configuration associated with a search space,
wherein the search space configuration indicates that the search space is associated with a first CORESET group and a second CORESET group, and
wherein the slot is associated with a control channel monitoring occasion that is associated with the search space, wherein the one or more processors are further configured to:
activate an active CORESET group, of the first CORESET group or the second CORESET group, based at least in part on the slot type, wherein the CORESET is included in the active CORESET group.

33. The UE of claim 32, wherein the first CORESET group is associated with the full-duplex slot type and the second CORESET group is associated with the half-duplex slot type, wherein the slot type is the half-duplex slot type, and wherein the active CORESET group is the second CORESET group, wherein the one or more processors are further configured to:
switch, for another control channel monitoring occasion, included in another slot, that is associated with the search space, the active CORESET group from the second CORESET group to the first CORESET group based at least in part on the other slot being the full-duplex slot type; and
receive, during the other slot, another control channel communication using another CORESET, of the one or more CORESETs, that is included in the first CORESET group, based at least in part on switching the active CORESET group.

34. The UE of claim 24, wherein the one or more processors are further configured to:
transmit, to the network node, a capability report indicating that the UE supports adapting CORESET configurations according to slot types, and wherein the reception of the control channel communication using the configuration that is based at least on part on the slot type is based at least in part on the transmission of the capability report.

35. A network node for wireless communication, comprising:
a memory; and
one or more processors, coupled to the memory, configured to:
transmit control resource set (CORESET) configuration information, associated with a user equipment (UE), that is associated with one or more CORESETs; and
transmit, during a slot, a control channel communication, for the UE, via a CORESET of the one or more CORESETs, the CORESET being associated with a configuration that is based at least on part on a slot type associated with the slot, the slot type including at least one of a full-duplex slot type or a half-duplex slot type.

36. The network node of claim 35, wherein the CORESET configuration information indicates a set of frequency domain resources associated with the CORESET, wherein the one or more processors are further configured to:
perform one or more operations associated with the CORESET using:
only a subset of frequency domain resources of the set of frequency domain resources if the slot type is the full-duplex slot type, or
the set of frequency domain resources if the slot type is the half-duplex slot type, and
wherein the subset of frequency domain resources includes frequency domain resources that do not overlap in a frequency domain with uplink resources or guard band resources of the slot.

37. The network node of claim 35, wherein the CORESET configuration information is associated with a search space configuration associated with a search space that is associated with a first CORESET and a second CORESET of the one or more CORESETs,
wherein the slot is associated with a control channel monitoring occasion that is associated with the search space, and
wherein the CORESET is the first CORESET if the slot type is the full-duplex slot type or the second CORESET if the slot type is the half-duplex slot type.

38. The network node of claim 37, wherein the first CORESET is associated with a first set of frequency domain resources and the second CORESET is associated with a second set of frequency domain resources, and
wherein the first set of frequency domain resources do not overlap, in a frequency domain, with uplink resources or guard band resources of the full-duplex slot type.

39. The network node of claim 35, wherein the CORESET configuration information is associated with a search space configuration associated with a search space,
wherein the search space configuration indicates that the search space is associated with a first CORESET group and a second CORESET group, and
wherein the slot is associated with a control channel monitoring occasion that is associated with the search space, wherein the one or more processors are further configured to:
activate an active CORESET group, of the first CORESET group or the second CORESET group, based at least in part on the slot type, wherein the CORESET is included in the active CORESET group.

40. The network node of claim 35, wherein the one or more processors are further configured to:
receive a capability report indicating that the UE supports adapting CORESET configurations according to slot types, and wherein the transmission of the control channel communication using the configuration that is based at least on part on the slot type is based at least in part on the reception of the capability report.
